(19) United States
(12) Patent Application Publication
(10) Pub. No.: US 2026/0120100 A1
(43) Pub. Date: Apr. 30, 2026

(54) DEVICES, METHODS, AND NON-TRANSITORY COMPUTER-READABLE MEDIA FOR TRUSTED ANONYMITY OF INDIVIDUALS, ENTITES, AND THINGS

(71) Applicant: MASTERCARD INTERNATIONAL INCORPORATED, Purchase, NY (US)

(72) Inventor: Przemek Praszczalek, Williamsburg, VA (US)

(21) Appl. No.: 19/009,050

(22) Filed: Jan. 3, 2025

Related U.S. Application Data
(60) Provisional application No. 63/618,076, filed on Jan. 5, 2024.

(51) Int. Cl. G06Q 20/40

(52) U.S. Cl. CPC G06Q 20/401

(57) ABSTRACT

Devices, methods, and non-transitory computer-readable media for perform a digital identity affirmation regarding an anonymous identity of an individual. A device may include a memory, a communication interface configured to communicate with a partner device, and an electronic processor that is configured to receive first information regarding an anonymous identity of an individual, perform a digital identity affirmation regarding the anonymous identity of the individual based on the first information that is received, and transmit second information regarding the digital identity affirmation to the partner device, the second information indicating an amount of trust of the anonymous identity.

### CROSS-REFERENCE TO RELATED APPLICATION

The present application claims the benefit of, and priority to, U.S. Provisional Application No. 63/618,076, filed on Jan. 5, 2024, the entire contents of which are incorporated herein by reference.

### FIELD OF THE INVENTION

The present disclosure relates generally to privacy-enhancing and secure identification and/or affirmation of legitimate individuals, entities and/or digital devices in a digital economy (i.e., people, businesses, and things, incl. AI agents, bots, etc.). More specifically, the present disclosure relates to devices, systems, methods, and non-transitory computer-readable media with permissioned, privacy-enhancing and trusted anonymity of such individuals, entities, and things (e.g., Internet of Things).

### SUMMARY

In some aspects, the present disclosure includes a server including: a memory, a communication interface configured to communicate with a partner device, and an electronic processor that is configured to receive first information regarding an anonymous identity of an individual, perform a digital identity affirmation regarding the anonymous identity of the individual based on the first information that is received, and transmit second information regarding the digital identity affirmation to the partner device, the second information indicating an amount of trust of the anonymous identity.

In some aspects, the present disclosure includes a method including: receiving, with an electronic processor, first information regarding an anonymous identity of an individual; performing, with the electronic processor, a digital identity affirmation regarding the anonymous identity of the individual based on the first information that is received; and transmitting, with the electronic processor, second information regarding the digital identity affirmation to a partner device, the second information indicating an amount of trust of the anonymous identity.

In some aspects, the present disclosure includes a non-transitory computer-readable medium including instructions that, when executed by an electronic processor, cause the electronic processor to perform a set of operations including: controlling a communication interface to receive first information regarding an anonymous identity of an individual; performing a digital identity affirmation regarding the anonymous identity of the individual based on the first information that is received; and controlling the communication interface to transmit second information regarding the digital identity affirmation to a partner device, the second information indicating an amount of trust of the anonymous identity.

### BRIEF DESCRIPTION OF THE FIGURES

FIG. 1 is a block diagram illustrating an example system for trusted anonymity of an individual (or an entity, or a thing), in accordance with various aspects of the present disclosure.

FIG. 2 is a flow diagram illustrating a comparative example of components of an individual's private identity.

FIG. 3 is a flow diagram illustrating a second comparative example of an individual's private identity.

FIG. 4 is a diagram illustrating a market landscape of an individual's private identity.

FIG. 5 is a flow diagram illustrating an example impact of the system of FIG. 1 performing trusted anonymity of an individual, in accordance with various aspects of the present disclosure.

FIG. 6 is a flow diagram illustrating an example flow of FIG. 5 when the trusted anonymity is performed successfully despite the individual's identity being fragmented, obfuscated, or otherwise hidden from third parties, in accordance with various aspects of the present disclosure.

FIG. 7 is a flow diagram illustrating an example flow of the individual's identity being fragmented and the individual being one of a person, business, or IoT device, in accordance with various aspects of the present disclosure.

FIG. 8 is a flow diagram illustrating an example flow of the individual's identity being fragmented due to micro identities, in accordance with various aspects of the present disclosure.

FIG. 9 is a flow diagram illustrating an example flow of a trusted anonymity four-party model, in accordance with various aspects of the present disclosure.

FIG. 10 is a flow diagram illustrating an example flow of discovering trusted partners as sources of identity signals for a given identity profile, in accordance with various aspects of the present disclosure.

FIG. 11 is a flow diagram illustrating an example of an identity engine, in accordance with various aspects of the present disclosure.

FIG. 12 is a flow diagram illustration an operation of the identity engine of FIG. 11, in accordance with various aspects of the present disclosure.

FIG. 13 is a block diagram illustrating components of a trusted identity service resolver, an identity trust engine, a privacy engine, in accordance with various aspects of the present disclosure.

FIG. 14 is a block diagram illustrating details of the components of the trusted identity service resolver of FIG. 13, in accordance with various aspects of the present disclosure.

FIG. 15 is a block diagram illustrating details of the components of the identity trust engine of FIG. 13, in accordance with various aspects of the present disclosure.

FIG. 16 is a block diagram illustrating details of the components of the privacy engine of FIG. 13, in accordance with various aspects of the present disclosure.

FIG. 17 is a flow diagram illustrating another example operation of the identity engine of FIG. 11, in accordance with various aspects of the present disclosure.

FIG. 18 is a flow diagram illustrating an example flow of a trusted identity service, in accordance with various aspects of the present disclosure.

FIG. 19 is a diagram illustrating a risk-assessed identity profile and a trusted identity profile, in accordance with various aspects of the present disclosure.

FIG. 20 is a diagram illustrating example signals that may be used in the trusted anonymity four-party model, in accordance with various aspects of the present disclosure.

FIG. 21 is a diagram illustrating example multi-domain identity network signals, in accordance with various aspects of the present disclosure.

FIG. 22 is a flow diagram illustrating a neural network for trusted anonymity, in accordance with various aspects of the present disclosure.

FIG. 23 is a diagram illustrating a first aspect of a multi-layer neural network for trusted anonymity, in accordance with various aspects of the present disclosure.

FIG. 24 is a diagram illustrating a second aspect of the multi-layer neural network for trusted anonymity, in accordance with various aspects of the present disclosure.

FIG. 25 is a diagram illustrating a deep multi-layer neural network for trusted anonymity, in accordance with various aspects of the present disclosure.

FIG. 26 is a flow diagram illustrating the deep multi-layer neural network of FIG. 25, in accordance with various aspects of the present disclosure.

FIG. 27 is a diagram illustrating an example of building trust based on connected accounts, identities, and new data signals, in accordance with various aspects of the present disclosure.

FIG. 28 is a diagram illustrating an example of identity affirmation with open banking, in accordance with various aspects of the present disclosure.

FIG. 29 is a diagram illustrating an example of building trust based on connected accounts and open banking signals, in accordance with various aspects of the present disclosure.

### DETAILED DESCRIPTION OF THE EMBODIMENTS

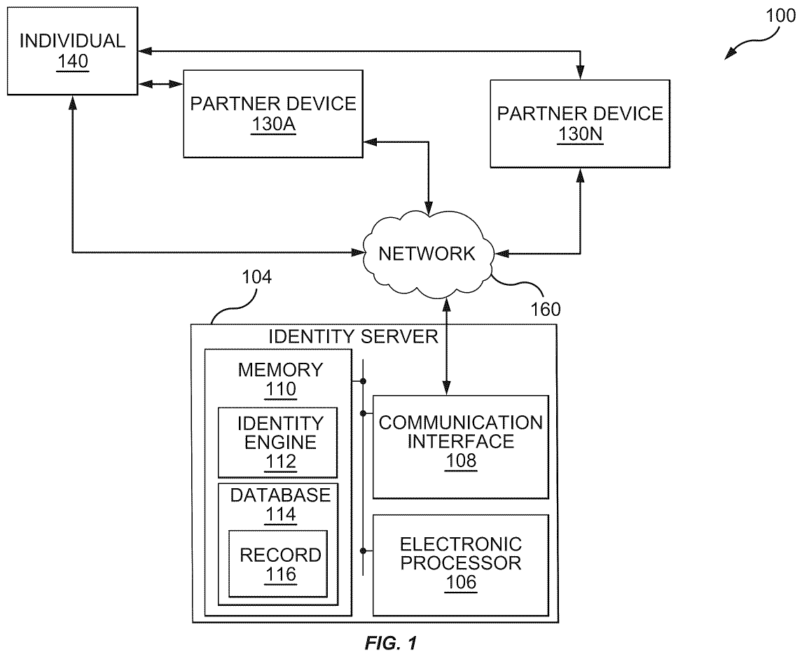

FIG. 1 is a block diagram illustrating an example system for trusted anonymity of an individual (or an entity, or an IoT device), in accordance with various aspects of the present disclosure. In the example of FIG. 1, the system 100 includes an identity server 104, a first partner device 130A, a second partner device 130N, an individual 140, and a network 160.

The identity server 104 may be owned by, or operated by or on behalf of, an administrator. The identity server 104 may also be implemented by one or more networked computer servers.

The identity server 104 includes an electronic processor 106, a communication interface 108, and a memory 110. The electronic processor 106 is communicatively coupled to the communication interface 108 and the memory 110. The electronic processor 106 is a microprocessor or another suitable processing device. The communication interface 108 may be implemented as one or both of a wired network interface and a wireless network interface. The memory 110 is one or more of volatile memory (e.g., RAM) and non-volatile memory (e.g., ROM, FLASH, magnetic media, optical media, et cetera). In some examples, the memory 110 is also a non-transitory computer-readable medium. Although shown within the identity server 104, memory 110 may be, at least in part, implemented as network storage that is external to the identity server 104 and accessed via the communication interface 108. For example, all or part of memory 110 may be housed on the “cloud.”

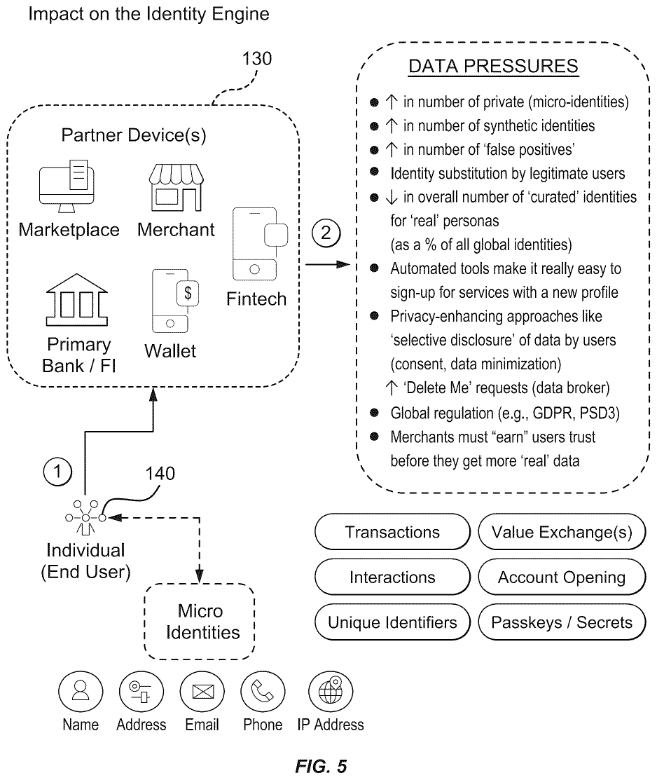

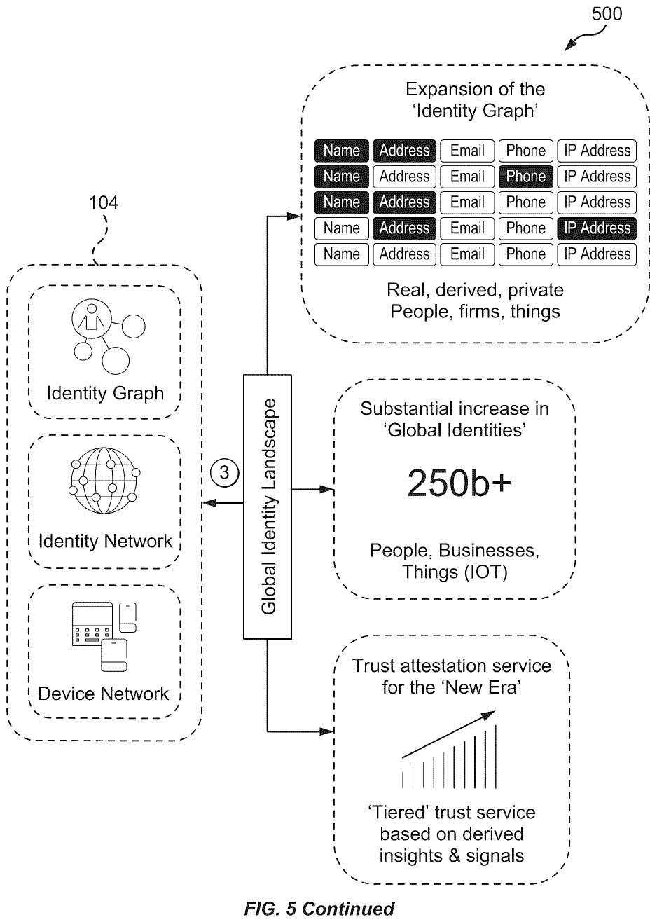

The identity engine 112 may be stored within a transitory or non-transitory portion of the memory 110. The identity engine 112 includes machine readable instructions that are executed by the electronic processor 106 to perform the functionality of the identity server 104 as described below with respect to FIG. 5-17.

The memory 110 may include a database 114 for storing information about individuals. The database 114 may be an RDF database, i.e., employ the Resource Description Framework. Alternatively, the database 114 may be another suitable database with features similar to the features of the Resource Description Framework, linked data, and various non-SQL databases, knowledge graphs, etc. The database 114 may include a plurality of records. Each record may be associated with and contain personal information about one individual. For example, the personal information may include user-provided data, data insights, risk scores, account details, and identity data. Additionally, in the illustrated embodiment, record 116 may be associated with the individual 140, and other N records may be respectively associated with one of N other individuals (not expressly shown in FIG. 1).

In some examples, the individual 140 is a single person. In other examples, the individual 140 may be a person, an entity (e.g., a business), a thing (e.g., an IoT device), or a combination thereof.

The first partner device 130A may also be implemented by a single computing device or one or more networked computer servers. The first partner device 130A includes an electronic processor in communication with memory. The electronic processor is a microprocessor or another suitable processing device, the memory is one or more of volatile memory and non-volatile memory. The communication interface may be a wireless or wired network interface.

An application, which contains software instructions implemented by the electronic processor of the first partner device 130A to perform the functions of the first partner device 130A as described herein, is stored within a transitory or a non-transitory portion of the memory. The application may have a graphical user interface that facilitates interaction between the individual 140 and the first partner device 130A.

The first partner device 130A may include or be in communication with a point-of-sale system (POS), e.g., a mobile POS system (such as a mobile card reader), a web portal (Internet site), or a digital gateway, which can facilitate collection and processing of data from the user/entity/thing. As discussed herein, the first partner device 130A may use the mobile POS system to, among other things, read a partner-specific identification asset (not shown and considered to be part of the block “individual 140”) associated with the individual 140 to verify the identity of the individual 140. The partner-specific identification asset may be a credit card, debit card, a digital card from a digital wallet, or other trusted digital representation (e.g., a Verifiable Credential).

The first partner device 130A may communicate with the identity server 104 over the network 160. The network 160 is preferably (but not necessarily) a wireless network, such as a wireless personal area network, local area network, or other suitable communication network. The first partner device 130A may directly communicate with the identity server 104 (not shown) or indirectly communicate over the network 160.

In an embodiment, the memory of the first partner device 130A may include a database and software. The database of the first partner device 130A may include information about the individual 140 and other individuals, as set forth herein. The software of the first partner device 130A may facilitate interaction between the first partner device 130A and individuals (e.g., the individual 140) and allow for the first partner device 130A to track the interactions as described in greater detail below.

The identity server 104 may likewise communicate with partner devices other than the first partner device 130A, for example, the second partner device 130N (collectively referred to as “partner device(s) 130”). The second partner device 130N is similar to the first partner device 130N in structure and functionality. Therefore, description of the second partner device 130N is not provided to avoid redundant descriptions.

The term “partner”, as used herein, encompasses any organizations engaging with individuals, including but not limited to, businesses, non-governmental organizations, and other charitable institutions (including governmental organizations). The term “partner” may also be synonymous to “third-party.”

The term “individual”, as used herein, encompasses a person, entity, or thing that seeks to interact with an organization or entity, including but not limited to, seeking access to goods and/or services (e.g., an individual registering for a digital account, an individual shopping on at a digital marketplace, an individual seeking disbursement of insurance funds, etc.). The workings of the identity server 104 and the partner device(s) 130 will be described in additional detail in FIG. 5-17.

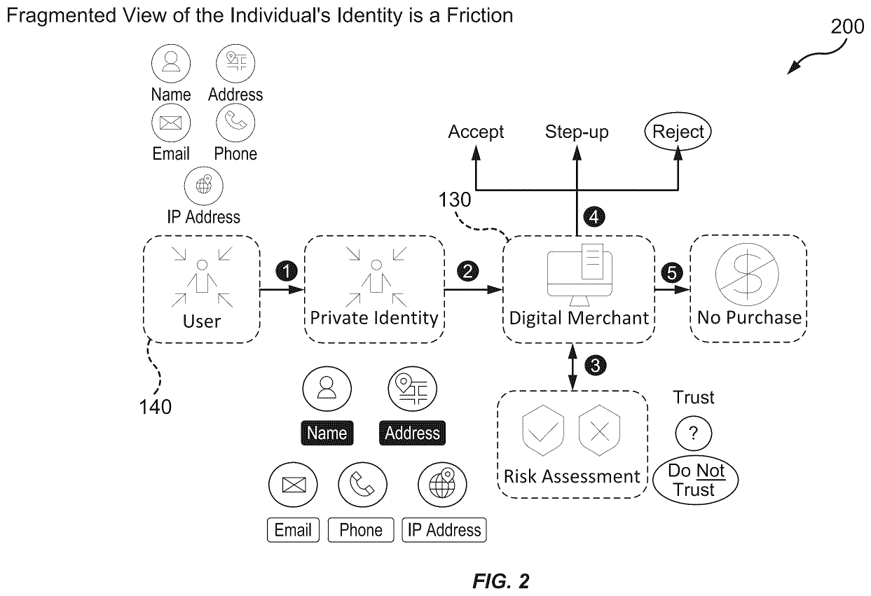

FIG. 2 is a flow diagram illustrating a comparative example 200 of components of an individual's private identity. As illustrated in FIG. 2, the individual 140 has several components that form a complete identity of the individual 140. The components may include a name, an address, an email, a phone, and an IP address of the individual 140. However, the components may also include more or less than these data elements about the individual 140.

The complete identity may include only a few data elements and/or signals. However, the complete identity may also include dozens, hundreds, thousands, or even millions of data elements and/or signals, especially when data management becomes increasingly automated and augmented by digital tools and assistants over time.

The individual 140 may select a subset of those components (e.g., a name and an address) to create an identity that is more “private” than the complete identity of the individual 140 (at operation 1). The individual 140 may use this “private identity” with a partner device 130 (e.g., at a merchant's website) to request access to a resource associated with the partner device (at operation 2).

The partner device 130 may perform a risk assessment on whether to the trust the individual 140 based on the “private identity” that was provided to the partner device 130 (operation 3). The risk assessment may be performed internally or externally with the assistance of a third-party risk assessment entity.

In response to receiving results from the risk assessment, the partner device 130 may take several actions with respect to the request by the individual 140. The partner device 130 may accept the request, step-up identity verification of the individual 140, or reject the request. In the example of FIG. 2, the partner device 130 rejected the request based on the risk assessment (at operation 4).

In response to rejecting the request, the partner device 130 does not allow the individual 140 to have access to the resource. For example, the partner device 130 may notify the individual 140 that “no purchase”can be made (at operation 5).

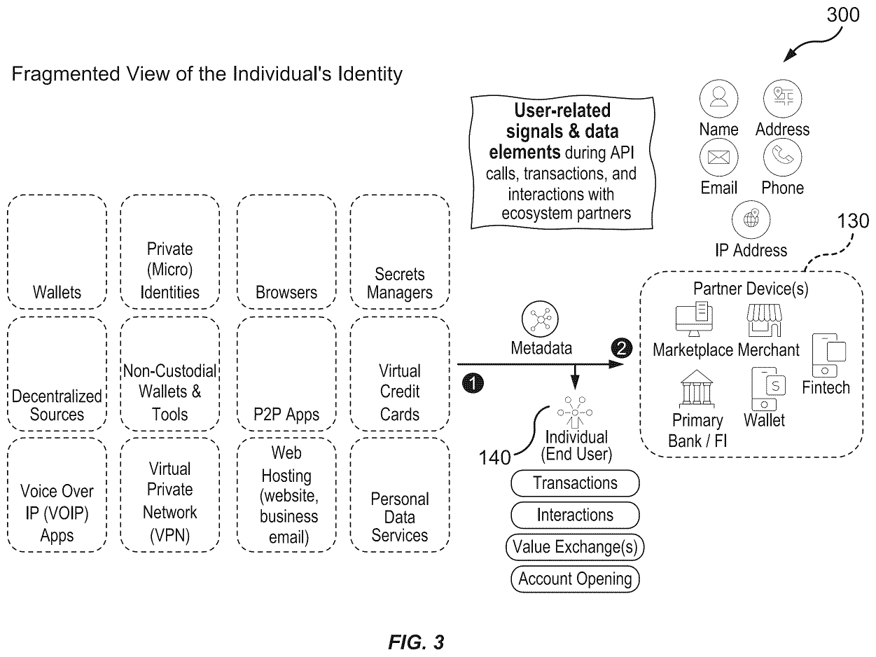

FIG. 3 is a flow diagram illustrating a second comparative example 300 of an individual's private identity. As illustrated in FIG. 3, unlike FIG. 2, the individual 140 has many fragmented components that form a complete identity of the individual 140.

In addition to the components described above in the comparative example 200, the components in the comparative example 300 that form a complete, partial, or otherwise obfuscated identity of the individual 140 may further include digital wallets, private (micro) identities, browsers, password/secret managers, decentralized sources, non-custodial wallets and tools, person-to-person applications, virtual credit cards, Voice Over IP applications, Virtual Private Networks, web hosting, personal data services, and/or any other digital entity that may identify some aspect of the individual 140.

Just like the comparative example 200, in the comparative example 300, the individual 140 may use some or all of the components in the comparative examples 200 and 300 to form a “private identity” (at operation 1). However, in the comparative example 300, the “private identity” may be or further include metadata or other information that is associated with transactions, interactions, value exchange(s), account opening(s), or other suitable information regarding the individual 140.

Unlike the comparative example 200, the individual 140 may use this metadata as the “private identity” with the partner device 130 (e.g., at a merchant's website) to request access to a resource associated with the partner device (at operation 2). However, while this “private identity” is more private than the “private identity” of FIG. 2 in the sense that the metadata is less personally identifiable information than the name and address in FIG. 2, the metadata is also harder for the partner device 130 to perform a risk assessment.

In order to protect both the partner device 130 and the individual 140 from cyberattacks and/or fraud, but also to validate “good/real users” overall, the partner device 130 needs to be able to perform a thorough risk assessment even when the individual 140 provides the metadata from private and disparate sources.

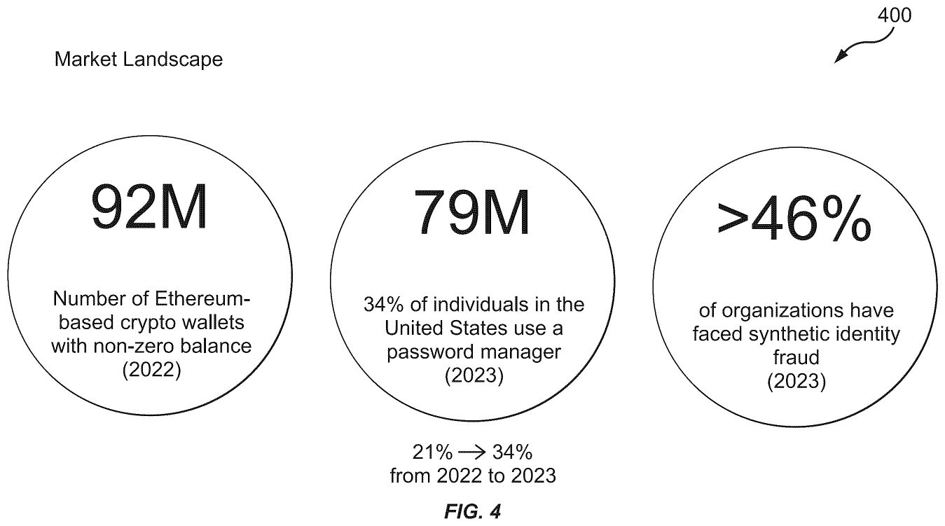

FIG. 4 is a diagram illustrating a market landscape 400 of an individual's private identity. As illustrated in FIG. 4, the market landscape in 2022 includes 92 million Ethereum-based crypto wallets with a non-zero balance. Additionally, in 2023, 79 million people, 34% of the U.S. population uses a password manager. Lastly, greater than 46% of organizations have faced synthetic identity fraud in 2023.

FIG. 5 is a flow diagram illustrating an example 500 of the system of FIG. 1 performing trusted anonymity of an individual, in accordance with various aspects of the present disclosure. In the example 500, the individual 140 uses micro identities to provide a name, an address, an email, a phone, and an IP address to the partner device 130 (at operation 1). Unlike the comparative example 200, all of the name, the address, the email, the phone, and the IP address are provided in the example 500 and these components provided to the partner device 130 by the individual 140 have been anonymized to some extent using micro identities.

The partner device 130 requests the identity server 104 to determine whether the partner device 130 should trust the anonymized identity of the individual 140 (at operation 2). The request by the partner device 130 may include transactions, interactions, unique identifiers, value exchange(s), account opening(s), passkey(s)/secret(s), and/or other suitable identification information either provided by or already associated with the individual 140.

The request by the partner device 130 also involves certain data pressures. First, the absolute number of different micro identities, the number of synthetic identities, and the number of “false positives” continually increases over time. Second, there is expected identity substitution by legitimate users. Third, the overall number of “curated” identities for “real” personas is decreasing (as a % of all global identities). Fourth, automated tools make it easy to sign up for services with a new identity profile. Fifth, privacy-enhancing approaches, like “selective disclosure” of data by users (consent, data minimization), continue to increase. Indeed, the number of “Delete Me” requests (data broker) will likely continue to increase. Sixth, global regulation (e.g., GDPR, PSD3) continues to play significant role in data management. Lastly, merchants must “earn” a user's trust before the merchants are provided more “real” data from or about the user they are interacting with.

The identity server 104 includes an identity graph, an identity network, and a device network, and may include multiple disparate graphs and networks over time, as global identity data and metadata grows in number, type, origin, etc. In response to receiving the request from the partner device 130, the identity server 104 further expands the identity graph with the information included in the request including the anonymized identity components (at operation 3). The expansion of the identity graph addresses what is expected to be a substantial increase in “global identities” of people, businesses, and things that are anonymized in some aspect.

Additionally, the identity server 104 provides a trust attestation service for the “new era” of fragmented and anonymized identities. Additionally or alternatively, the identity server 104 provides a “tiered” trust service based on direct data as well as derived insights and signals, for example, signals and insights derived from the ever expanding identity graph, trusted data partners, permissioned data sources, public data, internal company data, etc.

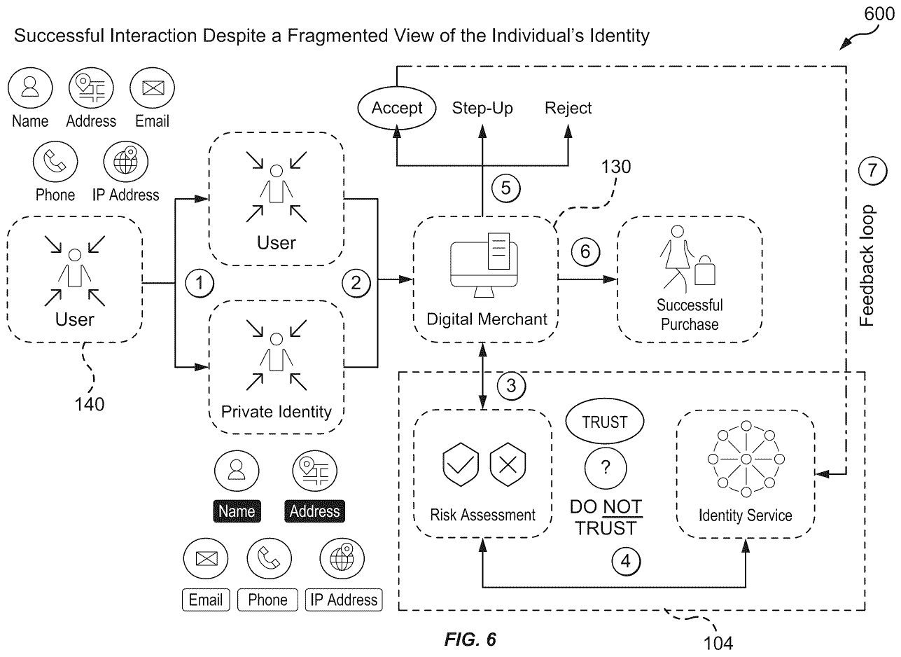

FIG. 6 is a flow diagram illustrating an example flow 600 of FIG. 1 when the trusted anonymity is performed successfully despite the individual's identity being fragmented, synthetic, privacy-enhanced, or otherwise obfuscated, in accordance with various aspects of the present disclosure. FIG. 6 is similar to FIG. 2 except the identity server 104 is able to confirm that the partner device 130 should trust the fragmented identity of the individual 140.

As illustrated in FIG. 6, the individual 140 has several components that form a complete identity of the individual 140. The components may include a name, an address, an email, a phone, and an IP address. However, the components may include more or less data of the individual 140.

The individual 140 may select a subset of those components (e.g., a name and e-mail) to create an identity that is more “private” than the complete identity of the individual 140 (at operation 1). The individual 140 may use this “private identity” with a partner device 130 (e.g., at a merchant's website) to request access to a resource associated with the partner device (at operation 2).

In the example of FIG. 6, the partner device 130 requests the identity server 104 to perform a risk assessment on whether to the trust the fragmented identity of the individual 140 based on the information that was provided to the partner device 130 (operation 3). The identity server 104 performs the risk assessment on whether to the trust the fragmented identity of the individual 140 by using an identity engine to process the information that was provided to the partner device 130 (operation 4).

In response to receiving results from the risk assessment, the partner device 130 may take several actions with respect to the request by the individual 140. The partner device 130 may accept the request, step-up identity verification of the individual 140, or reject the request. Unlike FIG. 2, in the example of FIG. 6, the partner device 130 accepts the request based on the risk assessment (at operation 5).

In response to accepting the request, the partner device 130 allows the individual 140 to have access to the resource. For example, the partner device 130 may notify the individual 140 that the purchase was a “successful purchase” (at operation 6).

Additionally, in response to accepting the request, the partner device 130 also notifies the identity server 104 of the acceptance of the request (operation 7). The identity server 104 incorporates the notification from the partner device 130 as feedback information into the identity engine of the identity server 104.

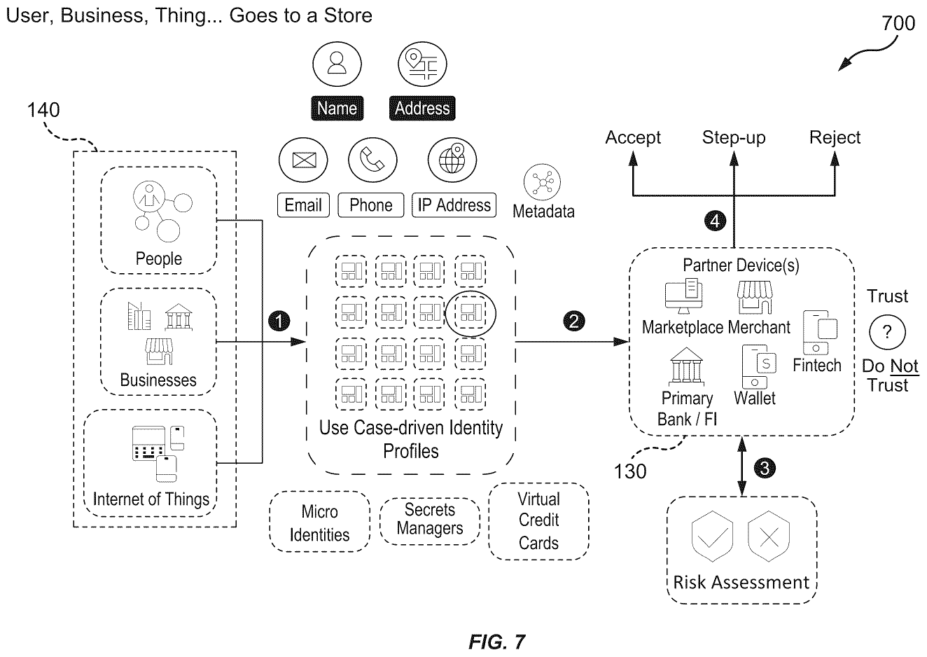

FIG. 7 is a flow diagram illustrating an example flow 700 of the individual's identity being fragmented and the individual being one of a person, business, or IoT device, in accordance with various aspects of the present disclosure. FIG. 7 is similar to FIG. 2 except the individual 140 in one of a person, business, or IoT device that has a plurality of use case-driven identity profiles.

As illustrated in FIG. 7, the individual 140 has several components that form a complete identity of the individual 140. The components may include a name, an address, an email, a phone, and an IP address of the individual 140. However, the components that form the complete identity of the individual 140 may also include more or less than these data elements, as indicated earlier.

The individual 140 may select a subset of those identity components (e.g., a name and an address) to create an identity that is more “private” than the complete identity of the individual 140 (at operation 1). The individual 140 may use this “private identity” with a partner device 130 (e.g., at a merchant's website) to request access to a resource associated with the partner device (at operation 2). Additionally, as illustrated in FIG. 7, the “private identity” is one of a plurality of use case-driven identity profiles, where each use case-driven identity profile is associated with one or more anonymizing identity sources, for example, micro identities, secret/password managers, virtual credit cards, or a combination thereof.

The partner device 130 may perform a risk assessment on whether to the trust the individual 140 based on the “private identity” that was provided to the partner device 130 (operation 3). The risk assessment may be performed internally or externally with the assistance of a third-party risk assessment entity.

In response to receiving results from the risk assessment, the partner device 130 may take several actions with respect to the request by the individual 140. The partner device 130 may accept the request, step-up identity verification of the individual 140, or reject the request (at operation 4).

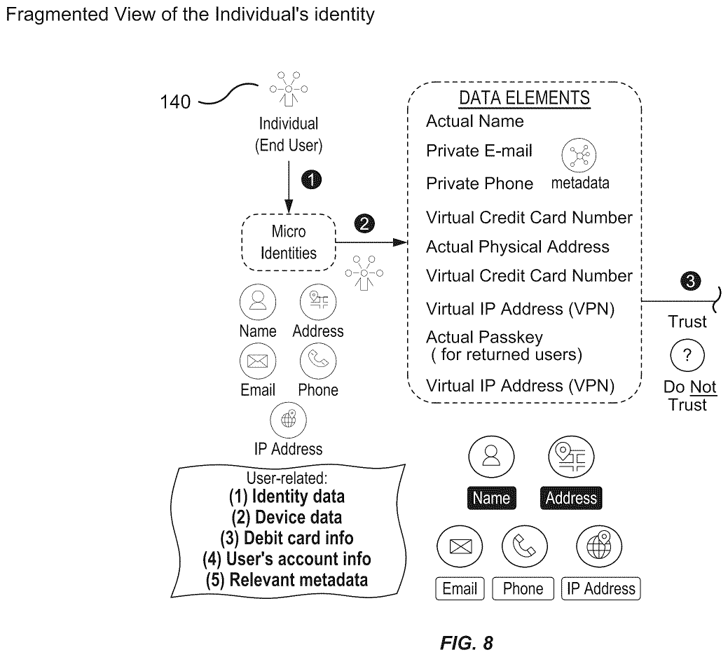

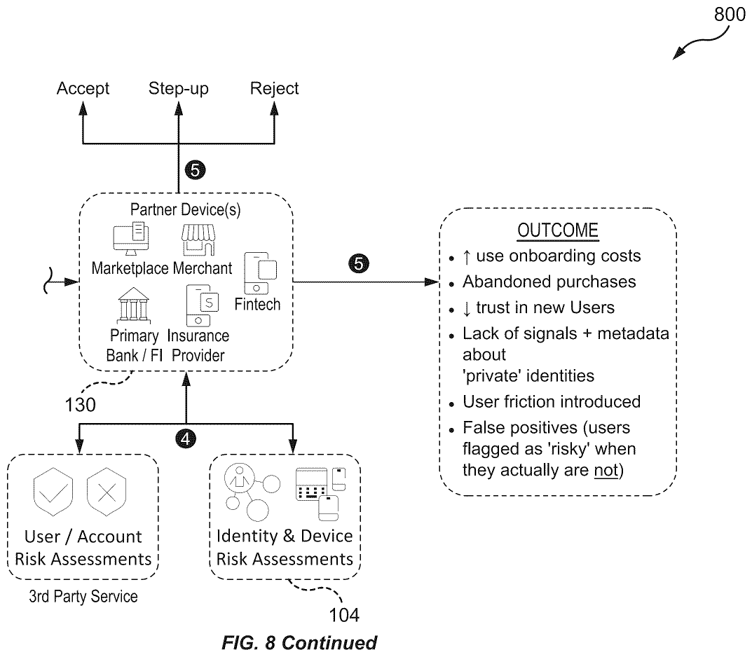

FIG. 8 is a flow diagram illustrating an example flow of the individual's identity being fragmented due to micro identities, in accordance with various aspects of the present disclosure. FIG. 8 is similar to FIGS. 2 and 6 except the identity server 104 is able to confirm that the partner device 130 should trust the fragmented and anonymized identity of the individual 140, where the anonymity is from the use of micro identities by the individual 140.

As illustrated in FIG. 8, the individual 140 has several components that form a complete identity of the individual 140. The components may include a name, an address, an email, a phone, and an IP address of the individual 140. However, the components may include more or less than these data elements.

The individual 140 may select a subset of those components (e.g., an actual name and a physical address) to create an identity that is more “private” than the complete identity of the individual 140 (at operation 1). However, rather than just selecting the subset of those components, the individual 140 may use micro identities to anonymize the “private” identity (at operation 2). As illustrated in FIG. 8, the identity of the individual 140 includes an actual name, a private email, a private phone number, a virtual credit card number, an actual physical address, a second virtual credit card number, a virtual IP address, an actual passkey (assuming the individual is a returning user), and a second virtual IP address.

The individual 140 may use this “anonymized private identity” with a partner device 130 (e.g., at a merchant's website) to request access to a resource associated with the partner device (at operation 3).

In the example of FIG. 8, the partner device 130 requests a third-party server to perform user and account risk assessments on whether to the trust the fragmented and anonymized identity of the individual 140 (operation 4). Additionally, in parallel, the partner device 130 also requests the identity server 104 to perform identity and device risk assessments on whether to the trust the fragmented and anonymized identity of the individual 140 based on the information that was provided to the partner device 130 (operation 4).

In response to receiving results from the risk assessments, the partner device 130 may take several actions with respect to the request by the individual 140. The partner device 130 may accept the request, step-up identity verification of the individual 140, or reject the request.

However, with respect to FIG. 8, the addition of anonymized components of an identity of the individual 140 causes several issues. First, the anonymized components require more risk assessments, which means an increase in the cost of onboarding a user. Second, more purchases may become abandoned because the partner device 130 has to perform more step-up verifications or outright rejections of the individual 140. Third, there is a lack of signals and metadata about “private” identities. Fourth, there is additional friction introduced into the interaction between the individual 140 and the partner device 130. Fifth, there are more false positives created (i.e., individuals flagged as “risky” when an individual is not risky).

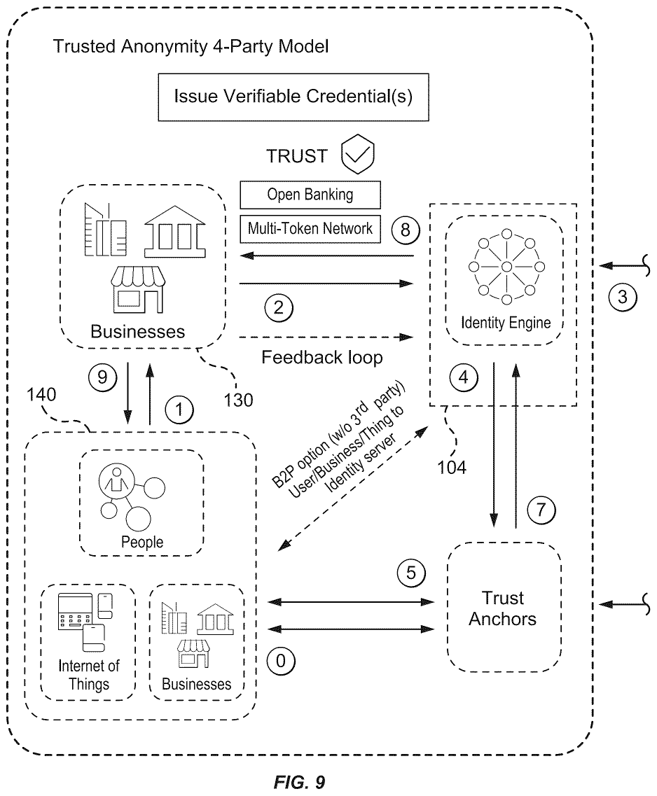

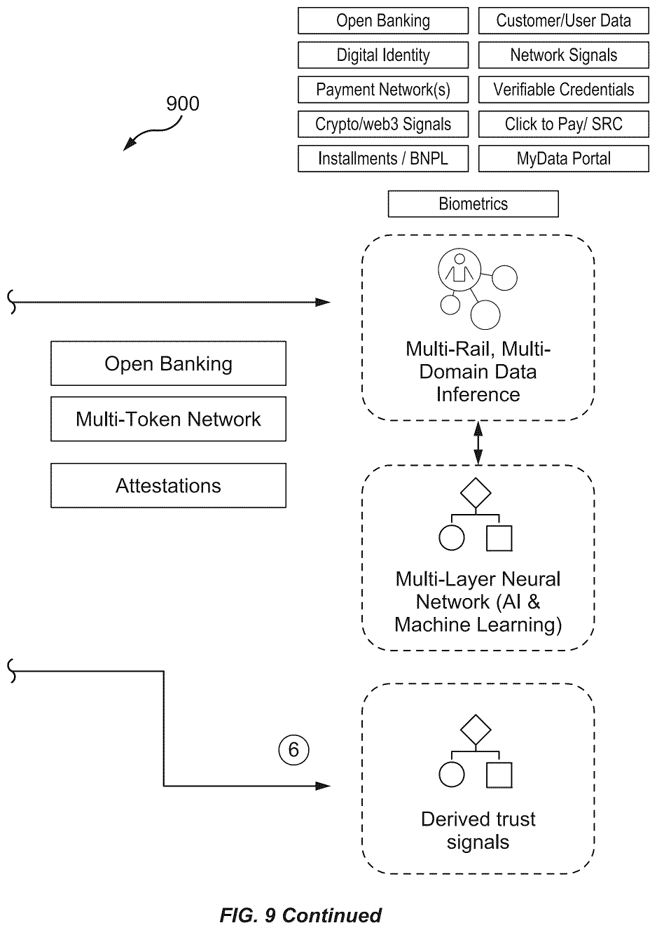

FIG. 9 is a flow diagram illustrating an example flow 900 of a trusted anonymity four-party model, in accordance with various aspects of the present disclosure. In the example of FIG. 9, the individual 140 accesses one or more anonymized identity services to generate the anonymized portion of the “anonymized private identity” as described in FIG. 8 (operation 0).

In the example flow 900, the individual 140 (e.g., person, business, or IoT device) requests access to a resource from the partner device (e.g., a business or merchant) (at operation 1). In the example flow 900, the partner device 130 requests the identity server 104 to determine whether the “anonymized private identity” of the individual 140 should be trusted (at operation 2). The identity server 104 analyzes the “anonymized private identity” to determine whether any inferences, insights, or signals are available in the “anonymized private identity.” For example, the identity server 104 may use an identity engine to perform a multi-rail, multi-domain data inference. The identity engine may determine whether the “anonymized private identity” has been associated with one or more of the following rails and/or domains: 1) open banking, 2) customer/user data, 3) a digital identity, 4) network signals, 5) payment network(s), 6) verifiable credentials, 7) crypto/web3 signals, 8) click to pay/SRC, 9) installments/BNPL, 10) a data portal, 11) biometrics, or any other internal or external data domains. In some examples, the identity engine may perform the multi-rail, multi-domain data inference by using a multi-layer neural network with artificial intelligence and machine learning.

In response to determining that the “anonymized private identity” has been associated with one or more rails and/or domains, the identity server 104 determines whether the one or more rails and/or domains are associated with one or more trust anchors (e.g., devices similar to the partner device 130). In response to determining that the one or more rails and/or domains are associated with the one or more trust anchors, the identity server 104 requests, from the one or more trust anchors, confirmation that an anonymized portion of “anonymized private identity” associated with the individual 140 is trustworthy (at operation 4).

In response to receiving the trustworthiness request from the identity server 104, the one or more trust anchors request permission from the individual 140 to provide a response to the trustworthiness request the identity server 104 (operation 5). In response to receiving permission from the individual 140 (operation 5), the one or more trust anchors provide the response to the trustworthiness request to the identity server 104 (operation 7). In response to receiving no permission from the individual 140 (operation 5), the one or more trust anchors may provide no response or send a denial response to the identity server 104 (operation 7).

In some examples, the response may include trust signals derived by the one or more trust anchors from directly interacting with the individual 140 (operation 6). For example, when the individual 140 has completed a successful purchase with a trust anchor, the trust anchor may basis a trust signal off the successful purchase.

In other examples, the response may include information from which the identity server may derive trust signals (operation 6). For example, when the individual 140 has completed a successful purchase with a trust anchor, the trust anchor may provide anonymous information regarding the successful purchase with the trust anchor.

In response to receiving the derived trust signals or information indicating trustworthiness of the individual 140 from the one or more trust anchors, the identity server 104 may compile one or more trustworthiness response and output a trustworthiness response to the partner device 130 (at operation 8). In some examples, the trustworthiness response may be a verifiable credential.

In response to receiving the trustworthiness response from the identity server 104, the partner device 130 may take several actions with respect to the request by the individual 140 (operation 9). The partner device 130 may accept the request, step-up identity verification of the individual 140, or reject the request.

Additionally, the partner device 130 may provide feedback to the identity server 104 regarding the action taken with respect to the individual 140. This feedback information may be used by the identity server 104 to improve the identity engine according to preferences desired by the owner of the partner device 130.

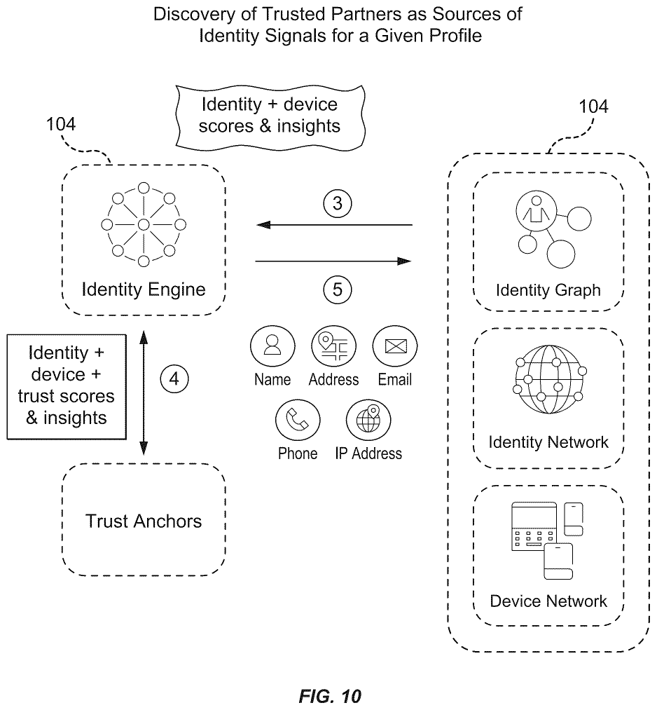

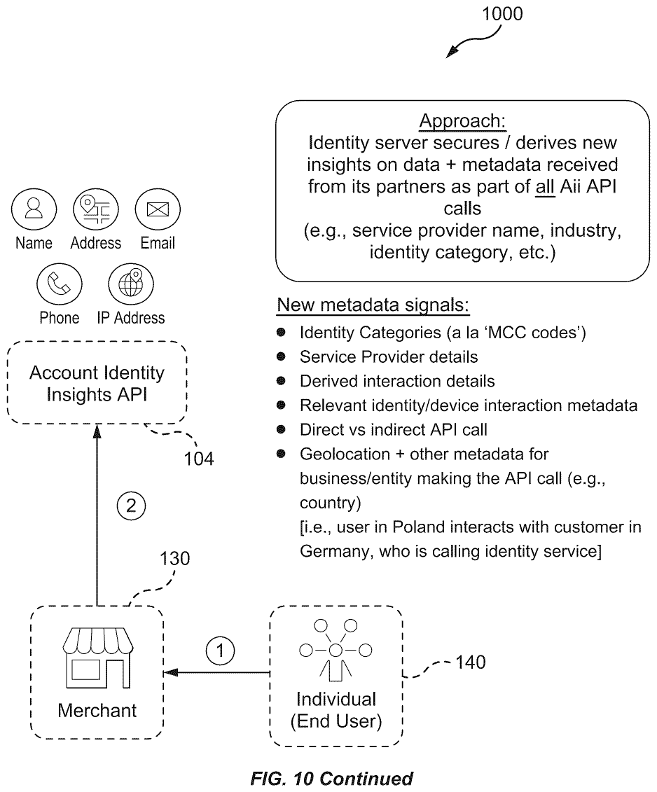

FIG. 10 is a flow diagram illustrating an example flow 1000 of discovering trusted partners as sources of identity signals for a given identity profile, in accordance with various aspects of the present disclosure. In the example flow 1000, the individual 140 (e.g., person, business, or IoT device) requests access to a resource from the partner device 130 (e.g., a business or merchant) and provides an identity profile (at operation 1).

In response to the request by the individual 140, the partner device 130 calls an Account Identity Insights API and provides the identity profile to the identity server 104 (at operation 2). The identity server 104 searches an identity graph, an identity network, and a device network based on the identity profile provided by the partner device 130.

In the example of FIG. 10, the identity server 104 identifies a merchant that has interacted with the provided identity profile in the identity network. Information from the identity graph, the identity network, and the device network of the identity server 104 (e.g., the provided identity profile and the identified merchant) is passed to the identity engine of the identity server 104 (at operation 3).

The identity engine of the identity server 104 contacts the identified merchant when the identified merchant is a trust anchor (at operation 4). Specifically, the identity server 104 requests trusts scores and insights from the identified merchant regarding its interaction with the individual 140.

In response to the request from the identity server 104, the identified merchant provides identity, device, and trust scores in addition insights to the identity server 104 (at operation 4). The identity server 104 may then generate identity categories (e.g., similar to merchant category codes (MCC) for payment transactions, etc.), where each identity category has service provider details, direct or derived interaction details, identity-related signals, and any relevant identity/device interaction metadata, etc. The generated identity categories in addition to the identity scores, device scores, trust scores, and trust insights may be used by the identity server 104 to determine whether the identity profile should be trusted.

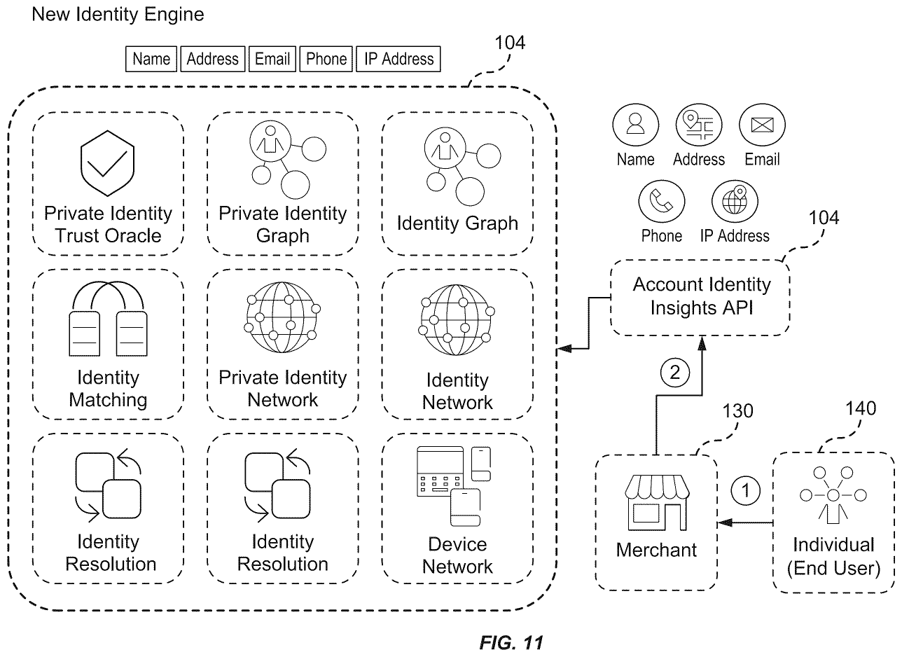

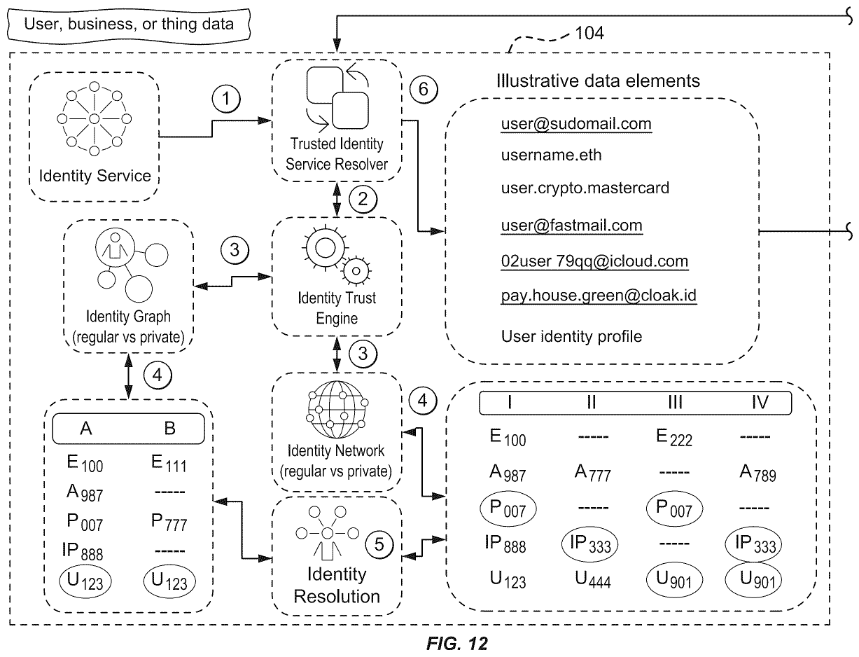

FIG. 11 is a flow diagram illustrating an example 1100 of an identity engine, in accordance with various aspects of the present disclosure. In the example 1100, the individual 140 interacts with the partner device 130 and provides anonymized information (e.g., an anonymized name, an anonymized address, an anonymized email, an anonymized phone, an anonymized IP address, a username of a partner) (operation 1). The partner device 130 calls the account identity insights API of the identity server 104 to access the identity engine of the identity server 104 (operation 2). The identity engine may include a private identity trust oracle, a private identity graph, a real identity graph, a first identity resolution (for real identity network), a private identity network, a real identity network, a second identity resolution (for private identity network), an identity matching service, and a device network.

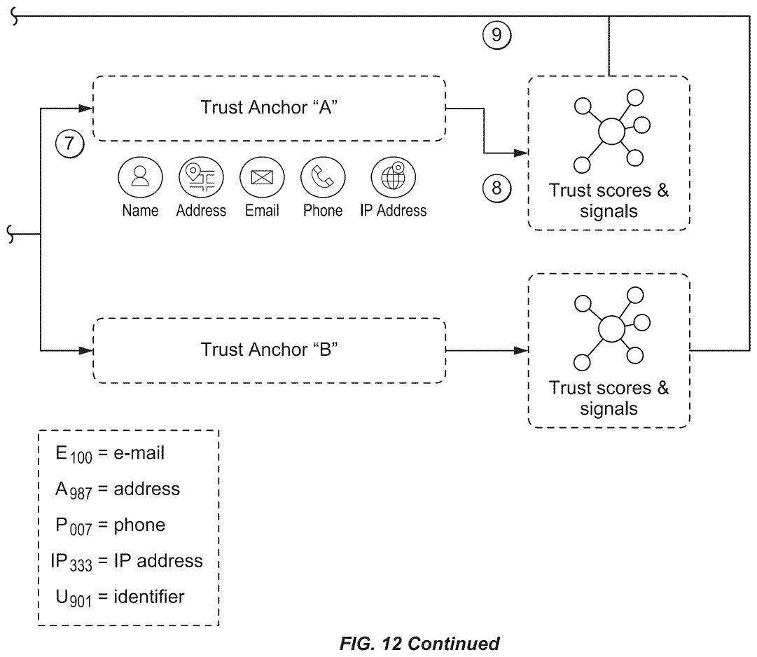

FIG. 12 is a flow diagram illustration an operation 1200 of the identity engine of FIG. 11, in accordance with various aspects of the present disclosure. The operation 1200 includes an identity service forwarding the anonymized information of the individual 140 to a trusted identity service resolver (operation 1). The trusted identity service resolver also passes the anonymized information to an identity trust engine (operation 2). The identity trust engine queries an identity network (e.g., a public or private identity network) and/or an identity graph (e.g., public or private identity graph) to identify any matching information with the anonymized information (operation 3).

The identity network matches a phone used at a first entity (e.g., a first partner device) and at a third entity (e.g., a third partner device), matches an IP address used at a second entity (e.g., a second partner device) and a fourth entity (e.g., a fourth partner device), matches a username used at the third entity and the fourth entity (operation 4). The first entity has a unique email, a unique address, a unique IP address, and a unique username associated with the phone that was used at the first entity and the second entity. The second entity has a unique address and a unique username associated with the IP address that was used at the second entity and the fourth entity. The third entity has a unique email and a unique phone associated with the username that was used at the third entity and the fourth entity. The fourth entity has a unique address in addition to the IP address used at the second entity and the username used at the third entity.

In some examples, the identity network returns all of the unique information when one of the data elements is matched to the anonymized information. In other examples, the identity network returns less than all of the unique information when one of the data elements is matched to the anonymized information. In yet other examples, the identity network returns some or all of the entities that were matched in the identity network to the anonymized information.

The identity graph matches a username used at entity A and entity B (at operation 4). The identity graph includes a unique email, a unique address, a unique phone, and a unique IP address associated with the username at the entity A. The identity graph includes a unique email and a unique phone associated with the username at the entity B.

In some examples, the identity network returns all of the unique information when one of the data elements is matched to the anonymized information. In other examples, the identity network returns less than all of the unique information when one of the data elements is matched to the anonymized information. In yet other examples, the identity graph returns some or all of the entities that were matched in the identity network to the anonymized information.

The identity resolution receives some or all of the unique information from the identity network and/or the identity graph. The identity resolution may use the unique information to determine whether the anonymized information is deficient or whether the individual 140 may be interested in a notification that their anonymized information may be incorrect or further supplemented with other anonymized information (operation 5).

In addition to the identity resolution, the trusted identity service resolver may also determine whether the anonymized information includes any information from a trust anchor (operation 6). For example, the trusted identity service resolver may determine whether one or more email addresses and/or one or more usernames are associated with a trust anchor.

As illustrated in FIG. 12, in response to identifying a trust anchor “A” and a trust anchor “B”, the trusted identity service resolver requests information associated with the corresponding email addresses and/or usernames from the trust anchor “A” and trust anchor “B” (operation 7). In response to receiving the request, the trust anchor “A” and the trust anchor “B” identify data elements (e.g., name, address, email, phone, IP address) associated with the corresponding email addresses and/or usernames and generate trust scores and signals (operation 8). The trust anchor “A” and the trust anchor “B” output the trust scores and signals to the trusted identity service resolver (operation 9).

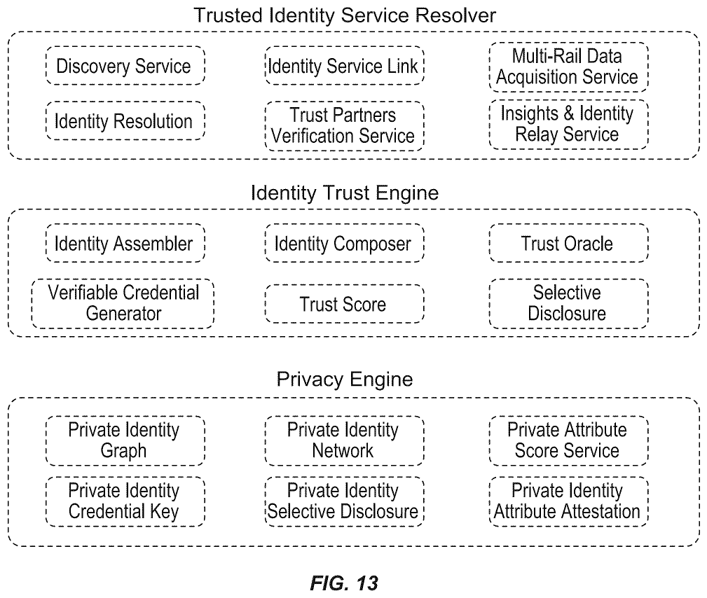

FIG. 13 is a block diagram illustrating components 1300 of a trusted identity service resolver, an identity trust engine, a privacy engine, in accordance with various aspects of the present disclosure. The trusted identity service resolver (e.g., the trusted identity service resolver of FIG. 12) may include a discovery service, an identity service link, a multi-rail data acquisition service, an identity resolution, a trust partners verification service, an insights and identity relay service. The identity trust engine (e.g., the identity trust engine of FIG. 12) may include an identity assembler, an identity composer, a trust oracle, a verifiable credential generator, a trust score, and a selective disclosure. The privacy engine may include a private identity graph, a private identity network, a private attribute score service, a private identity credential key, a private identity selective disclosure, and a private identity attribute attestation.

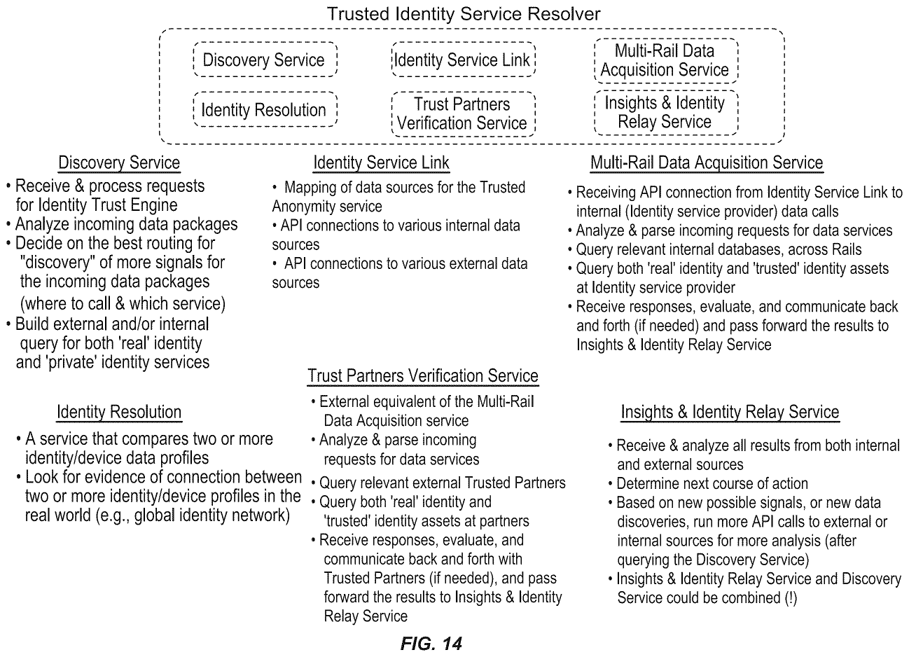

FIG. 14 is a block diagram illustrating details 1400 of the components of the trusted identity service resolver of FIG. 13, in accordance with various aspects of the present disclosure. In FIG. 14, the discovery service may receive and process requests for the identity trust engine. The discovery service may analyze incoming data packages. The discovery service may decide on the best routing for “discovery” of more signals for the incoming data packages (where to call and which service). The discovery service may also build external and/or internal query for both “real” identity and “private” identity services.

In FIG. 14, the identity service link may map data sources for the trusted anonymity service. The identity service link may facilitate API connections to various internal data sources. The identity service link may also facilitate API connections to various external data sources.

In FIG. 14, the multi-rail data acquisition service may receive API connection from the identity service link to internal identity server data calls. The multi-rail data acquisition service may analyze and parse incoming requests for data services. The multi-rail data acquisition service may query relevant internal identity server databases, across rails. The multi-rail data acquisition service may query both “real” identity and “trusted” identity assets at the identity server 104. The multi-rail data acquisition service may also receive responses, evaluate, and communicate back and forth (if needed) and pass forward the results to the insights and identity relay service.

In FIG. 14, the identity resolution is a service that compares two or more identity/device data profiles. Additionally, the identity resolution may also look for evidence of connection between two or more identity/device profiles in the real world (e.g., global identity network).

In FIG. 14, the trust partners verification service may be an external equivalent of the multi-rail data acquisition service. The trust partners verification service may analyze and parse incoming requests for data services. The trust partners verification service may query relevant external identity server trusted partners. The trust partners verification service may query both “real” identity and “trusted” identity assets at partners. The trust partners verification service may also receive responses, evaluate, and communicate back and forth with trusted partners (if needed), and pass forward the results to insights and identity relay service.

In FIG. 14, the insights and identity relay service may receive and analyze all results from both internal and external sources. The insights and identity relay service may determine next course of action. The insights and identity relay service may, based on new possible signals, or new data discoveries, run more API calls to external or internal sources for more analysis (after querying the discovery service). The insights and identity relay service may also insights and identity relay service and discovery Service may be combined.

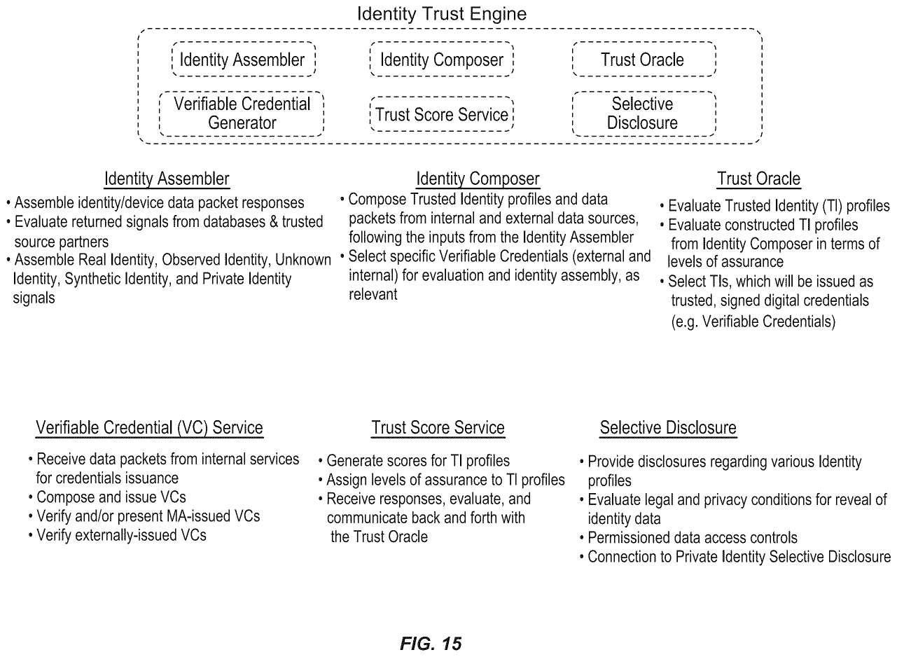

FIG. 15 is a block diagram illustrating details of the components of the identity trust engine of FIG. 13, in accordance with various aspects of the present disclosure. In FIG. 15, the identity assembler may assemble identity/device data packet responses. The identity assembler may evaluate returned signals from databases and trusted source partners. The identity assembler may also assemble real identity, observed identity, unknown identity, synthetic identity, and private identity signals.

In FIG. 15, the identity composer may compose trusted identity profiles and data packets from internal and external data sources, following the inputs from the identity assembler. The identity composer may also select specific verifiable credentials (external and internal) for evaluation and identity assembly, as relevant.

In FIG. 15, the trust oracle may evaluate trusted identity (TI) profiles. The trust oracle may evaluate constructed TI profiles from the identity composer in terms of levels of assurance. The trust oracle may also select TIs, which will be issued as trusted, signed digital credentials (e.g., verifiable credentials).

In FIG. 15, the verifiable credential (VC) service may receive data packets from identity server internal services for credentials issuance. the verifiable credential (VC) service may compose and issue VCs. The verifiable credential (VC) service may verify and/or present identity server-issued VCs. The verifiable credential (VC) service may also verify externally-issued VCs.

In FIG. 15, the trust score service may generate scores for TI profiles. The trust score service may assign levels of assurance to TI profiles. The trust score service may also receive responses, evaluate, and communicate back and forth with the trust oracle.

In FIG. 15, the selective disclosure may provide disclosures regarding various identity profiles. The selective disclosure may evaluate legal and privacy conditions for reveal of identity data. The selective disclosure may implement permissioned data access controls. The selective disclosure may also provide a connection to private identity selective disclosure.

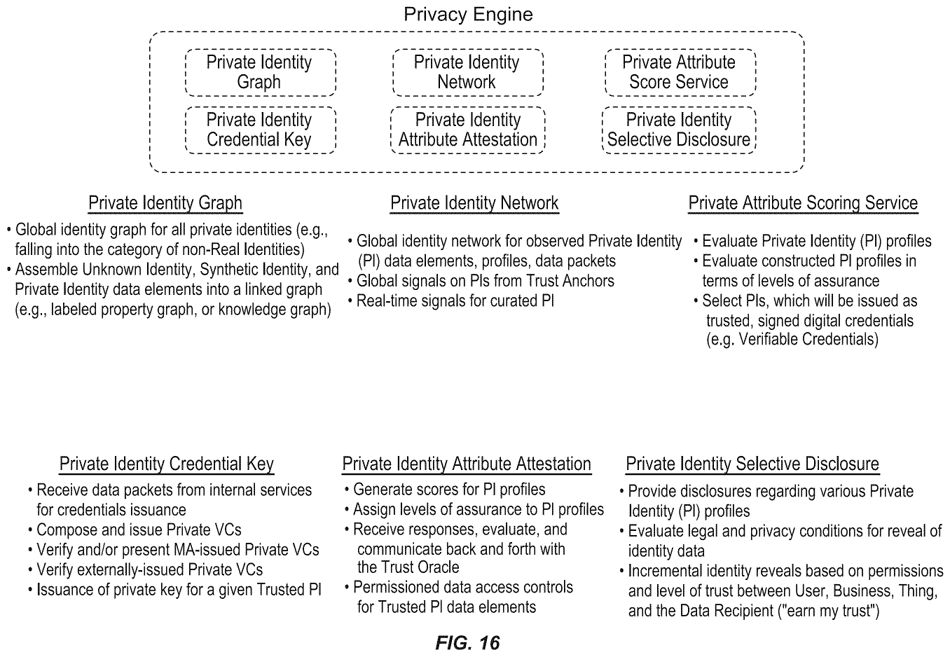

FIG. 16 is a block diagram illustrating details of the components of the privacy engine of FIG. 13, in accordance with various aspects of the present disclosure. In FIG. 16, the private identity graph is a global identity graph for all private identities (e.g., falling into the category of non-real identities). The private identity graph may assemble unknown identity, synthetic identity, and private identity data elements into a linked graph (e.g., labeled property graph, or knowledge graph).

In FIG. 16, the private identity network is a global identity network for observed private identity (PI) data elements, profiles, data packets. The private identity network may provide global signals on PIs from trust anchors. The private identity network may also provide real-time signals for curated PI.

In FIG. 16, the private attribute scoring services may evaluate private identity (PI) profiles. The private attribute scoring services may evaluate constructed PI profiles in terms of levels of assurance. The private attribute scoring services may select PIs, which will be issued as trusted, signed digital credentials (e.g. verifiable credentials).

In FIG. 16, the private identity credential key may receive data packets from identity server internal services for credentials issuance. The private identity credential key may compose and issue private VCs. The private identity credential key may verify and/or present identity server-issued private VCs. The private identity credential key may verify externally-issued private VCs. The private identity credential key may also issuance of private key for a given trusted PI.

In FIG. 16, the private identity attribute attestation may generate scores for PI profiles. The private identity attribute attestation may assign levels of assurance to PI profiles. The private identity attribute attestation may receive responses, evaluate, and communicate back and forth with the trust oracle. the private identity attribute attestation may also implement permissioned data access controls for trusted PI data elements.

In FIG. 16, the private identity selective disclosure may provide disclosures regarding various private identity (PI) profiles. The private identity selective disclosure may evaluate legal and privacy conditions for reveal of identity data. The private identity selective disclosure may incremental identity reveals based on permissions and level of trust between user, business, thing, and the data recipient (“earn my trust”).

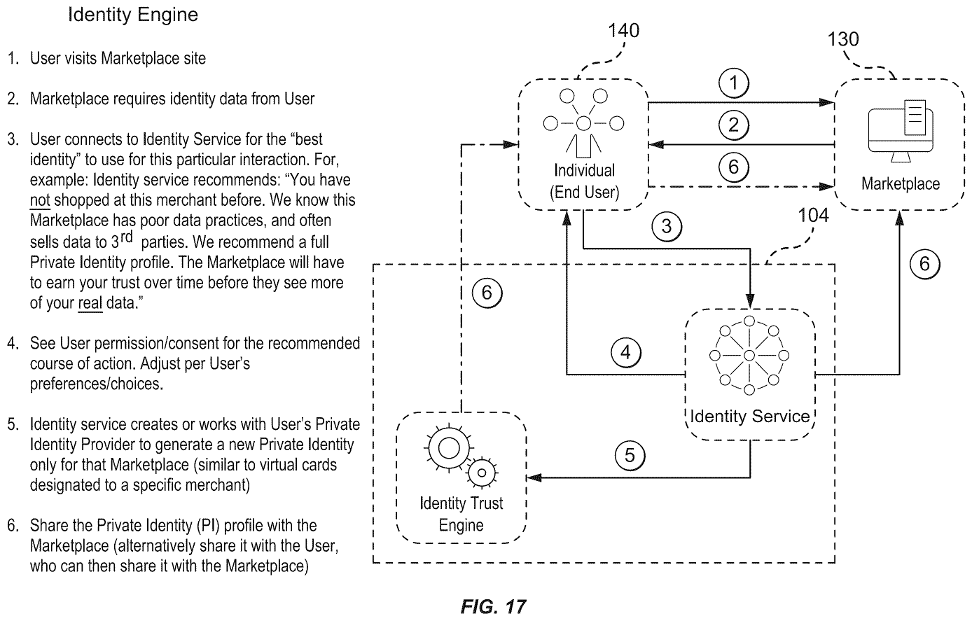

FIG. 17 is a flow diagram illustrating another example operation of the identity engine of FIG. 11, in accordance with various aspects of the present disclosure. In the example of FIG. 17, the individual 140 visits a marketplace website hosted by the partner device 130 (operation 1). The marketplace website hosted by the partner device 130 requests identity data from the individual 140 (operation 2).

The individual 140 connects to an identity service provided by the identity server 104 for the “best identity” to use for this interaction with the partner device 130 (operation 3). The identity server 104 may identify the partner device 130 and provide a notification to the individual 140 (operation 4). The notification stating “You have not shopped at this merchant before. We know this Marketplace has poor data practices, and often sells data to third parties. We recommend a full Private Identity profile. The Marketplace will have to earn your trust over time before they see more of your real data”, which could be partially revealed/shared over time, on permissioned basis.

The identity server 104 determines a user permission/consent for the recommended course of action and adjusts a private identity (PI) per a user's preferences/choices (operation 5). The identity server 104 creates or works with a user's private identity provider to generate a new private identity only for that marketplace (similar to virtual cards designated to a specific merchant) and shares the private identity (PI) profile with the marketplace (alternatively shares the PI with the individual, which lets the individual 140 share the PI with the marketplace) (operation 6).

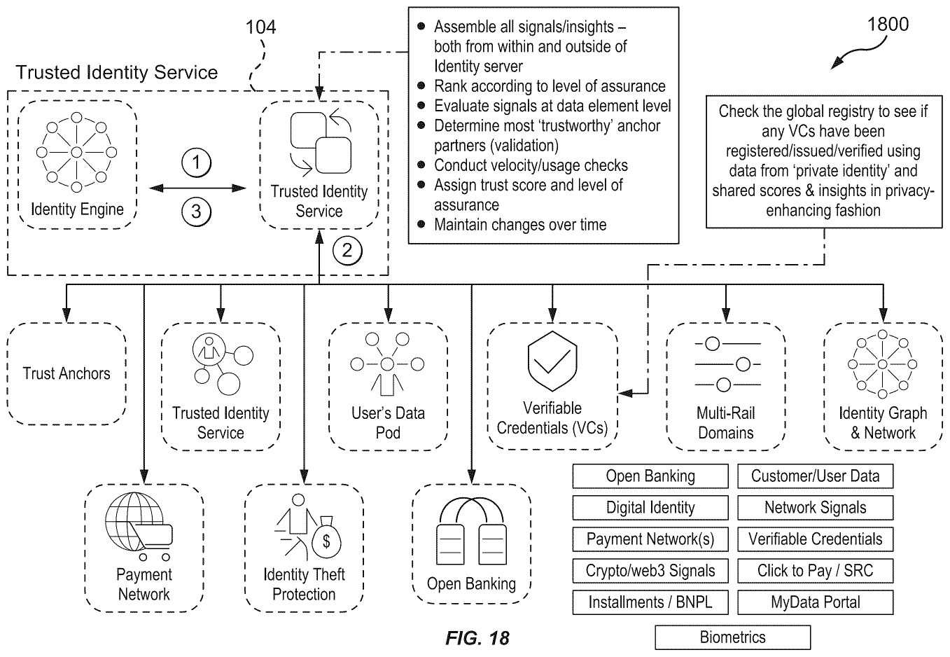

FIG. 18 is a flow diagram illustrating an example flow 1800 of a trusted identity service, in accordance with various aspects of the present disclosure. In the example of FIG. 18, a trusted identity service of the identity server 104 performs several operations. First, the trusted identity service assembles all signals/insights both from within, and external to, the identity server 104.

In some examples, the signals/insights from within the identity server 104 include signals/insights from an identity engine in the identity server 104. In some examples, the signals/insights from external to the identity server 104 includes signals/insights from some or all of the following: 1) trust anchors, 2) another trusted identity service, 3) a user's data pod and/or digital wallet, 4) verifiable credentials (VCs), 5) multi-rail domains, 6) an external identity graph and network, 7) a payment network, 8) an identity theft protection service, and 9) open banking.

Second, the trusted identity service ranks the assembled signals/insights according to level of assurance. Third, the trusted identity service evaluates signals at a data element level. For example, when the assembled signals/insights include a verifiable credential (VC), the trusted service may check the global registry to see if the VC has been registered/issued/verified using data from a “private identity” and scores and insights associated with the “private identity” may be shared in a privacy-enhancing fashion.

Fourth, the trusted identity service determines most “trustworthy” anchor partners (validation). Fifth, the trusted identity service conducts velocity/usage checks. Sixth, the trusted identity service assigns a trust score and a level of assurance. Seventh, the trusted identity service maintains changes over time.

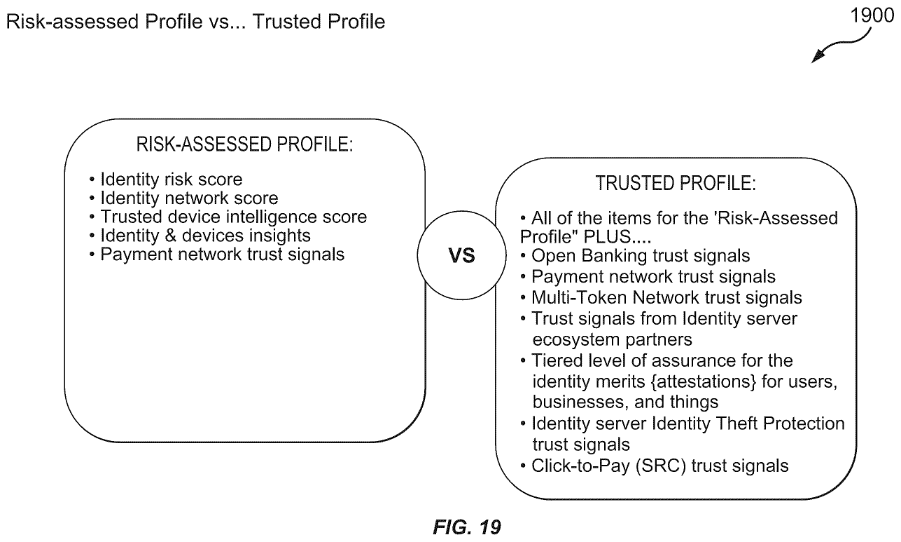

FIG. 19 is a diagram illustrating a comparison 1900 of a risk-assessed identity profile and a trusted anonymous profile, in accordance with various aspects of the present disclosure. In the comparison 1900, the risk-assessed identity includes an identity risk score, an identity network score, a trusted device intelligence score, identity and devices insights, and payment network trust signals.

In the comparison 1900, the trusted anonymous profile includes some or all of the components of the risk-assessed identity profile. Additionally, the trusted anonymous profile includes some or all of open banking trust signals, multi-token network trust signals, trust signals from identity server ecosystem partners, tiered level of assurance for the identity merits (attestations) for users, businesses, and things, Identity server Identity Theft Protection trust signals, and click-to-pay (SRC) trust signals.

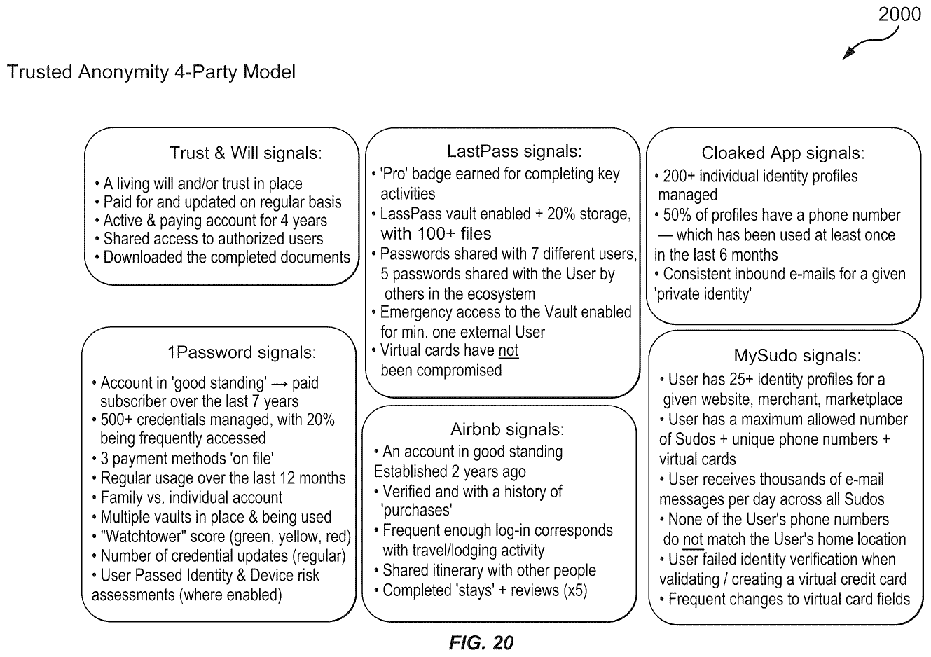

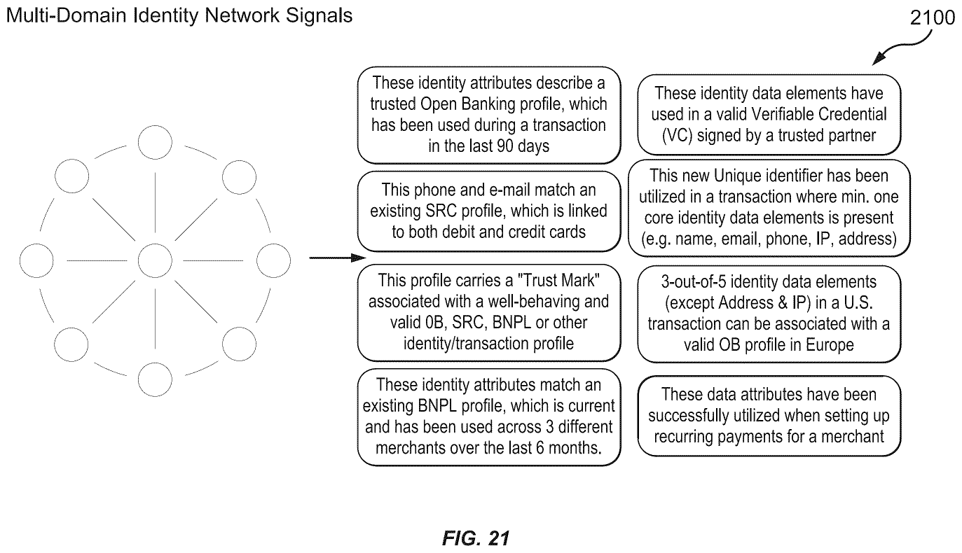

FIG. 20 is a diagram illustrating example signals 2000 that may be used in the trusted anonymity four-party model, in accordance with various aspects of the present disclosure. The example signals 2000 includes trust and will signals, secret/password manager signals, identity profile manager signals, and merchant interaction signals.

The trust and will signals may include a living will and/or trust in place, the will and/or trust are paid for and updated on a regular basis, a payment account active for four years or more, shared access to authorized users, and evidence of a download of the completed documents.

The secret/password manager signals may include a badge earned for completing key activities, a vault enabled storage (e.g., twenty percent or more usage with hundred or more files), passwords shared with seven different users, five passwords shared with the individual 140 by others in the ecosystem, emergency access to the value enabled for minimum of one other individual, virtual cards have not been compromised, account in “good standing,” paid subscriber for a number of years (e.g., seven or more years), a number of credentials managed (e.g., five hundred or more credentials), a percentage of credentials accessed (e.g., twenty percent or more), a number of payment methods on file (e.g., three or more payment methods), regular usage over a period of time (e.g., a year), family vs individual account, multiple accounts in place and being used, a score based on the vault, a number of credential updates, and the individual 140 passed identity and device risk assessments.

The identity profile manager signals may include a number of identity profiles managed (e.g., two hundred or more), a percentage of profiles have a phone number (e.g., fifty percent or more) used once in a period of time (e.g., last six months), consistent inbound e-mails for a given “private identity,” user has a number of identity profiles for a given website, merchant, or marketplace (e.g., twenty-five or more), user has a maximum number of allowed identity profiles with unique phone numbers and virtual payment cards, user receives a number of emails per day across all identity profiles (e.g., a thousand or more emails per day), all phone numbers associated with the individual 140 match a home location of the individual 140, a lack of a failed identity verification when validating and/or creating a virtual credit card, and frequent changes to virtual card fields.

The merchant interaction signals may include an account in good standing, an age of the account in good standing (e.g., opened two years ago), an account verified and with a history of purchases, frequent log-in activity that corresponds with accessing merchant resources (e.g., travel/lodging activity when the merchant is a travel merchant), shared information with other people (e.g., shared travel itinerary when the merchant is the travel merchant), completed interactions (e.g., stays), and a number of reviews of the merchant (e.g., five or more review of the merchant).

FIG. 21 is a diagram illustrating example multi-domain identity network signals 2100, in accordance with various aspects of the present disclosure. The example multi-domain identity network signals 2100 may include identity attributes that describe a trusted Open Banking profile, which has been used during a transaction in the last 90 days. The example multi-domain identity network signals 2100 may include identity data elements that have used in a valid Verifiable Credential (VC) signed by a trusted partner. The example multi-domain identity network signals 2100 may include a phone and an e-mail that match an existing SRC profile, which is linked to both debit and credit cards. The example multi-domain identity network signals 2100 may include a new Unique identifier that has been utilized in a transaction where a minimum of one core identity data elements is present (e.g., name, email, phone, IP, address). The example multi-domain identity network signals 2100 may include a profile that carries a “Trust Mark” associated with a well-behaving and valid OB, SRC, BNPL or other identity/transaction profile.

The example multi-domain identity network signals 2100 may include 3-out-of-5 identity data elements (except Address & IP) in a U.S. transaction can be associated with a valid OB profile in Europe. The example multi-domain identity network signals 2100 may include identity attributes that match an existing BNPL profile, which is current and has been used across three different merchants over the last six months. The example multi-domain identity network signals 2100 may also include data attributes that have been successfully utilized when setting up recurring payments for a merchant.

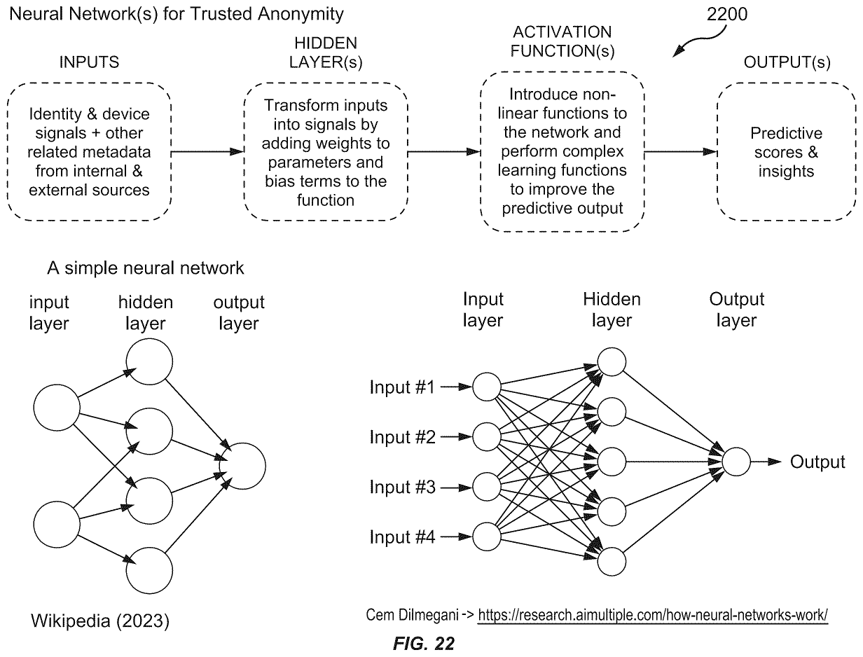

FIG. 22 is a flow diagram illustrating a neural network 2200 for trusted anonymity, in accordance with various aspects of the present disclosure. The neural network 2200 includes inputs, a hidden layer, an activation function, and an output. The inputs includes identity and device signals along with other related metadata from internal and external sources. The hidden layer transforms the inputs into signals by adding weights to parameters and bias terms to the input. The activation function introduces non-linear functions to the network and performs complex learning functions to improve the predictive output. The output includes predictive scores and insights.

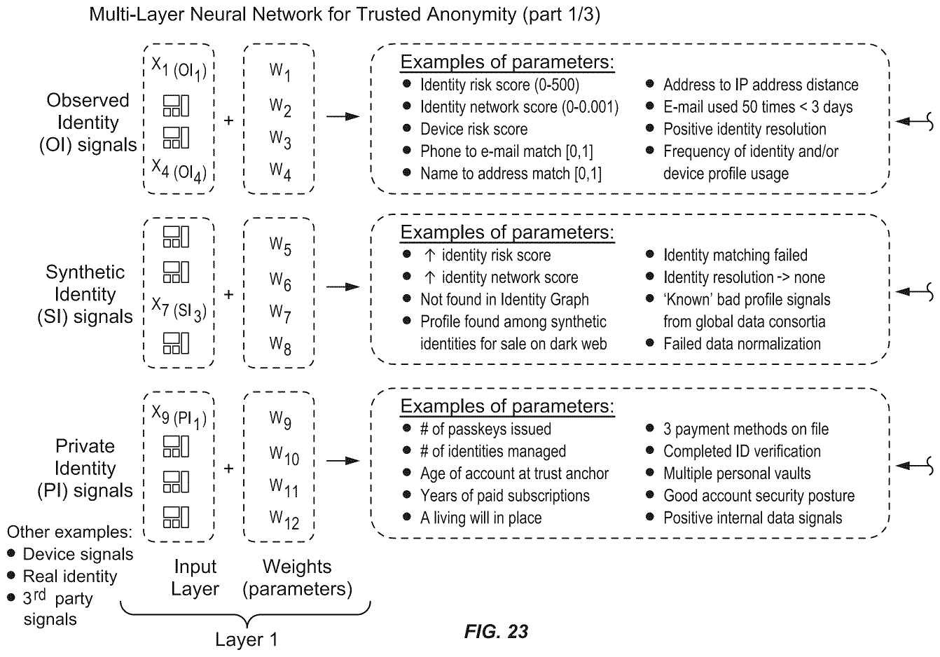

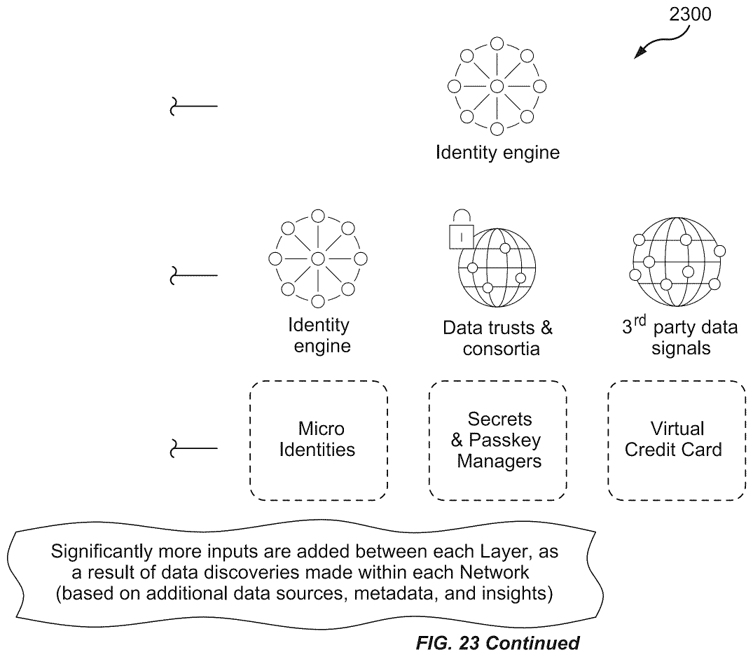

FIG. 23 is a diagram illustrating a first aspect 2300 of a multi-layer neural network for trusted anonymity, in accordance with various aspects of the present disclosure. The first aspect 2300 includes the input layer and the weights (parameters) of the multi-layer neural network.

The first aspect 2300 includes observed identity (OI) signals (e.g., OI₁ to OI₄) with added weights (e.g., weights W1 to W4). In some examples, the OI signals may include an identity risk score (e.g., 0-500), an identity network score (e.g., 0-0.001), a device risk score, a phone to e-mail match [0,1], a name to address match [0,1], an address to IP address distance, an e-mail used fifty times<3 days, a positive identity resolution, and/or a frequency of identity and/or device profile usage.

The first aspect 2300 includes synthetic identity (SI) signals (e.g., SI₁ to SI₄) with added weights (e.g., weights W5 to W8). In some examples, the SI signals may include an increase in identity risk score, an increase in identity network score, not found in identity graph, a profile found among synthetic identities for sale on dark web, an identity matching failed, an identity resolution->none, a ‘Known’ bad profile signals from global data consortia, and/or a failed data normalization. Likewise, it may also generate good signals supporting or increasing the level of trust in such an identity, including, but not limited to labeling an initial SI signal as a probable real identity, and forwarding for further assessment.

The first aspect 2300 also includes private identity (PI) signals (e.g., PI₁ to PI₄) with added weights (e.g., weights W9 to W12). In some examples, the PI signals may include a number of passkeys issued, a number of identities managed, an age of account at trust anchor, years of paid subscriptions, a living will in place, three payment methods on file, a completed ID verification, multiple personal vaults, a good account security posture, and/or positive internal data signals.

The first aspect 2300 may include other signals in addition to or in place of the signals provided above. For example, the first aspect 2300 may also include device signals, real identity signals, and/or third-party signals.

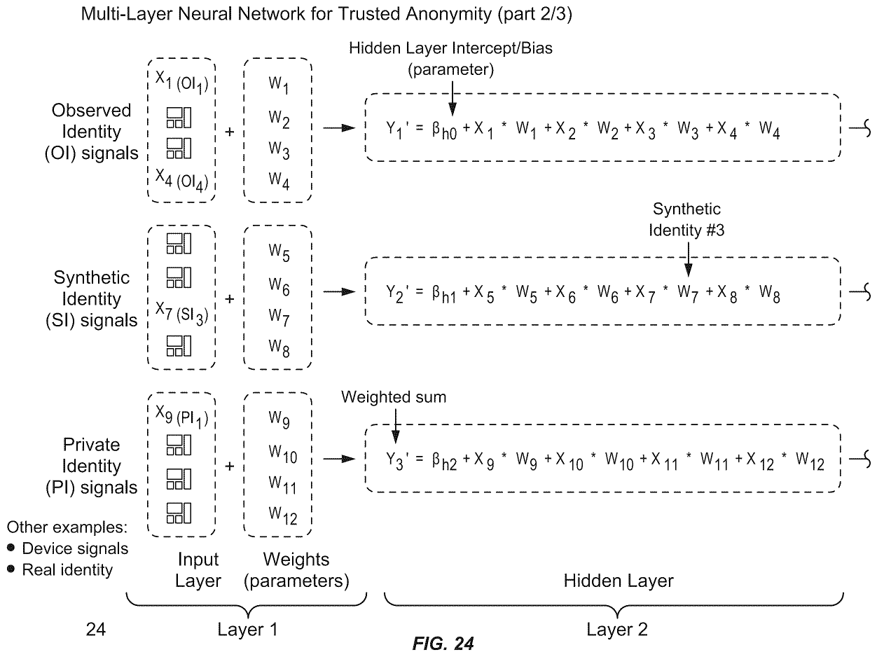

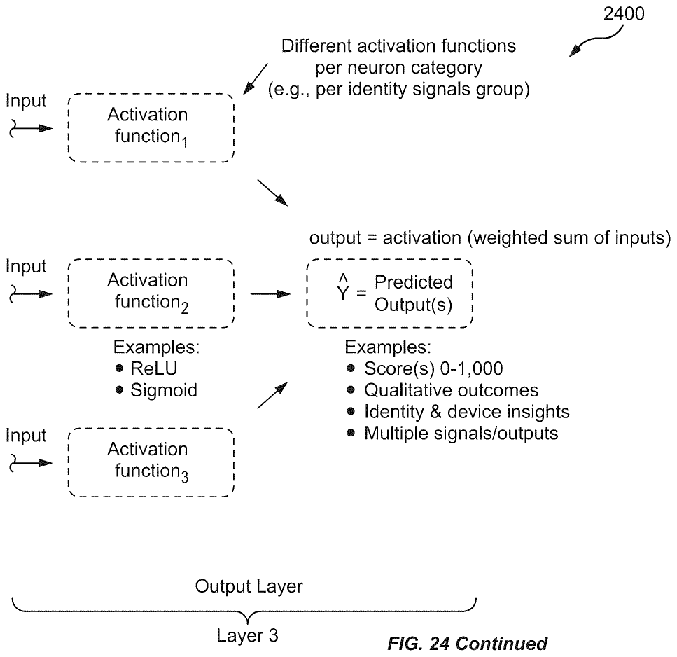

FIG. 24 is a diagram illustrating a second aspect 2400 of the multi-layer neural network for trusted anonymity, in accordance with various aspects of the present disclosure. The second aspect 2400 illustrates the hidden layer and the output layer of the multi-layer neural network in addition to the input layer and the weights.

The hidden layer includes a weighted sum for each of the OI signals, SI signals, and the PI signals. Each weighted sum includes an individual hidden layer intercept/bias parameter added to respective signals/weights.

The output layer includes an activation function for each neuron category (e.g., per identity signals group). In some examples, the activation function may include a Rectified Linear Unit (ReLU) activation function, a Sigmoid activation function, or other suitable activation function.

The collective output of the activation functions is a predicted output. In some examples, the predicted output may be a score (e.g., 0-1000), qualitative outcomes, identity and device insights, and multiple signals/outputs.

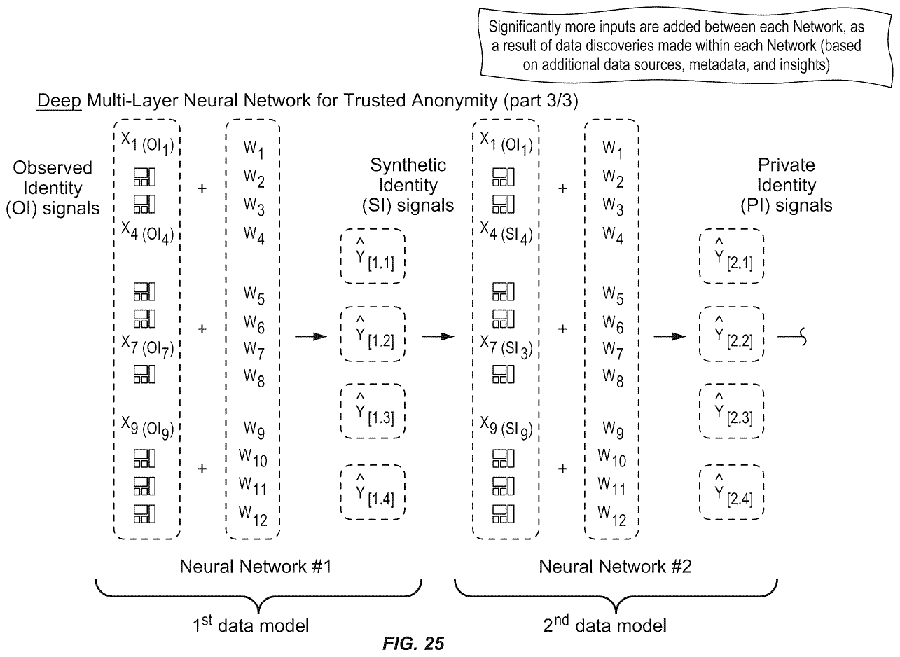

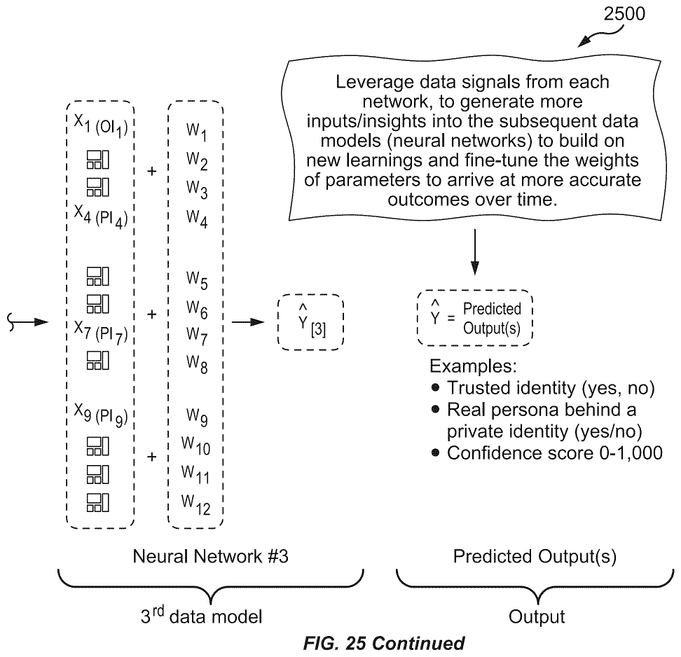

FIG. 25 is a diagram illustrating a deep multi-layer neural network 2500 for trusted anonymity, in accordance with various aspects of the present disclosure. The deep multi-layer neural network 2500 includes three distinct neural networks. A first neural network may include twelve OI signals and a corresponding twelve weights, which results in a first set of four predicted outputs that are input into a second neural network. The second neural network may include twelve SI signals and a corresponding twelve weights, which results in a second set of four predicted outputs that are input into a third neural network. The third neural network may include twelve PI signals and a corresponding twelve weights, which results in an overall predicted output. In some examples, the overall predicted output may be a trusted identity (e.g., yes or no), a real persona behind a private identity (yes or no), and/or a confidence score (e.g., 0-1000), or some other quantitative or qualitative data indicator.

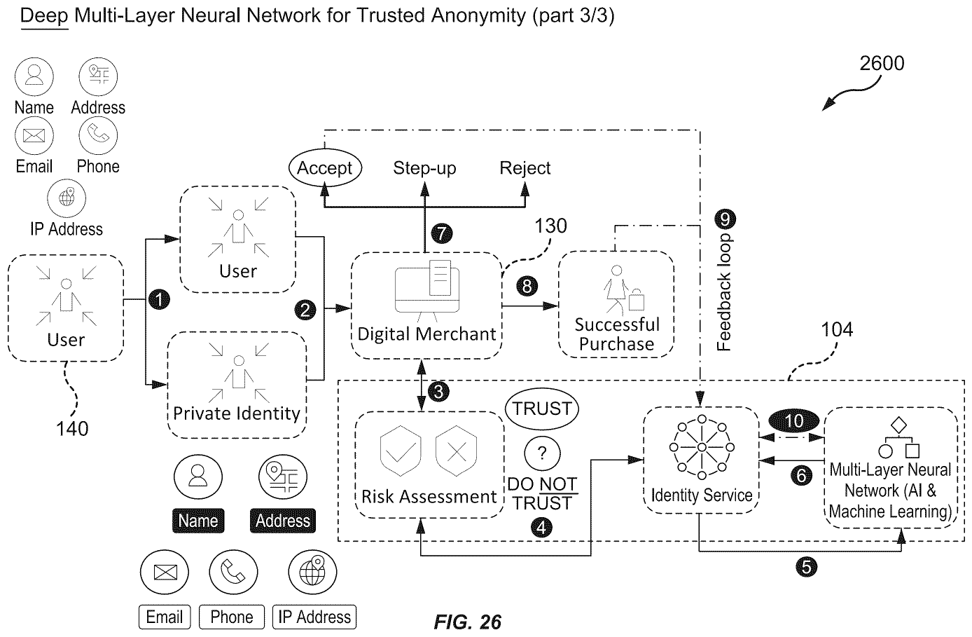

FIG. 26 is a flow diagram 2600 illustrating the deep multi-layer neural network of FIG. 25, in accordance with various aspects of the present disclosure. FIG. 26 is similar to FIG. 6.

As illustrated in FIG. 26, the individual 140 has several components that form a complete identity of the individual 140. The components may include a name, an address, an email, a phone, and an IP address of the individual 140, or many other data elements.

The individual 140 may select a subset of those components (e.g., a name and an address) to create an identity that is more “private” than the complete identity of the individual 140 (at operation 1). The individual 140 may use this “private identity” with a partner device 130 (e.g., at a merchant's website) to request access to a resource associated with the partner device (at operation 2).

In the example of FIG. 26, the partner device 130 requests the identity server 104 to perform a risk assessment on whether to the trust the fragmented identity of the individual 140 based on the information that was provided to the partner device 130 (operation 3). The identity server 104 performs the risk assessment on whether to the trust the fragmented identity of the individual 140 by using an identity service to process the information that was provided to the partner device 130 (operation 4).

The identity server 104 may use the identity service to request a multi-layer neural network (artificial intelligence and machine learning) to process the information that was provided to the partner device 130 (operation 5). The identity service receives the results from the multi-layer neural network (operation 6). The identity service may either provide the results from the multi-layer neural network to the partner device 130 or may further process the results to generate results in a standardized format. In either case, the identity server 104 may provide risk assessment results that were requested by the partner device 130 (operation 3).

In response to receiving the risk assessment results, the partner device 130 may take several actions with respect to the request by the individual 140. The partner device 130 may accept the request, step-up identity verification of the individual 140, or reject the request. In the example of FIG. 26, the partner device 130 accepts the request based on the risk assessment (at operation 7).

In response to accepting the request, the partner device 130 allows the individual 140 to have access to the resource. For example, the partner device 130 may notify the individual 140 that the purchase was a “successful purchase” (at operation 8).

Additionally, in response to accepting the request, the partner device 130 also notifies the identity service of the acceptance of the request by the individual 140 (operation 9). The identity server 104 incorporates the notification from the partner device 130 as feedback information into the multi-layer neural network of the identity server 104 (operation 10).

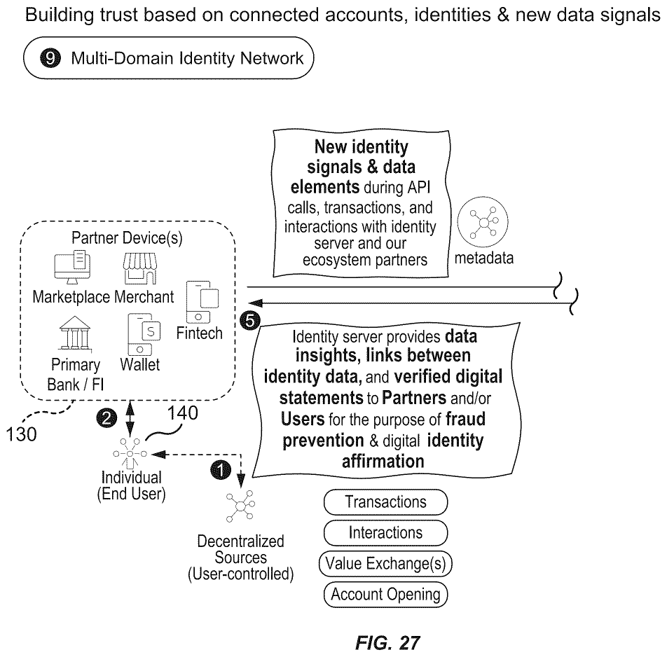

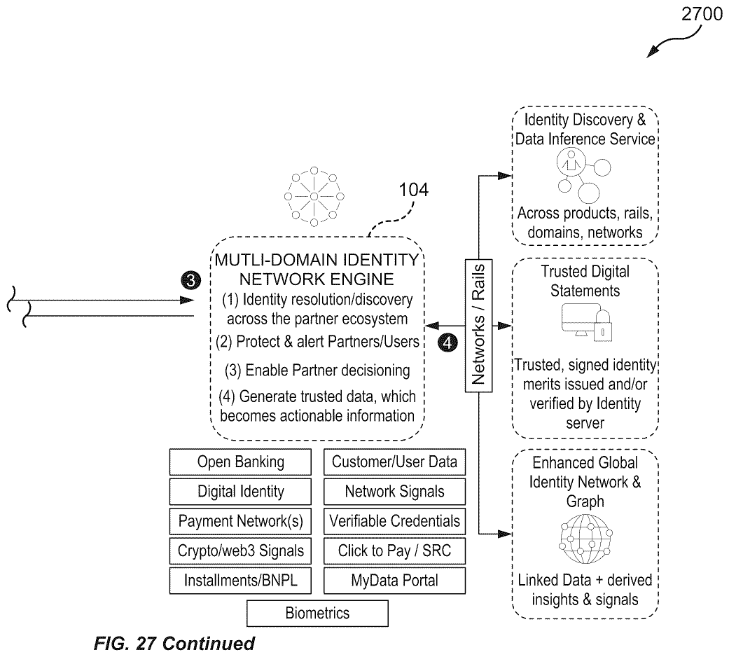

FIG. 27 is a diagram illustrating an example 2700 of building trust based on connected accounts, identities, and new data signals, in accordance with various aspects of the present disclosure. As illustrated in FIG. 27, the individual 140 has several components that form a complete identity of the individual 140. The components may include user-controlled decentralized sources of the individual 140, specifically, the components may be transactions, interactions, value exchange(s), and an account opening.

The individual 140 may select a subset of the decentralized sources components to create an anonymous identity that is more “private” than the complete identity of the individual 140 (at operation 1). The individual 140 may use this “private identity” with a partner device 130 (e.g., at a merchant's website) to request access to a resource associated with the partner device (at operation 2).

In the example of FIG. 27, the partner device 130 requests the identity server 104 to perform a risk assessment on whether to the trust the anonymous identity of the individual 140 based on the information that was provided to the partner device 130 (operation 3). The information provided to the identity server 104 includes metadata with identity signals and data elements during API calls, transactions, and interactions with the identity server 104 and/or ecosystem partners.

The identity server 104 performs the risk assessment on whether to the trust the anonymous identity of the individual 140 by using a multi-domain identity network engine to process the information that was provided to the partner device 130. The multi-domain identity network engine performs the following functions: 1) identity resolution/discovery across the partner ecosystem, 2) protect and alert partners/users, 3) enable partner decisioning, and 4) generate trusted data, which becomes actionable information. The multi-domain identity network engine performs the above functions by 1) performing an identity discovery and data inference service across products, rails, domains, and networks; 2) retrieving trusted digital statements that are trusted, signed identity merits that are issued and/or verified by the identity server 104; and 3) access an enhanced global identity network and graph to determine linked data in addition to derived insights and signals.

In response to receiving results from the risk assessment, the partner device 130 may take several actions with respect to the request by the individual 140 (operation 5). Specifically, the results from the risk assessment may include data insights, links between identity data, and verified digital statements to partners and/or users for the purpose of fraud prevention and digital identity affirmation. The partner device 130 may accept the request, step-up identity verification of the individual 140, or reject the request based on the results received from the identity server 104.

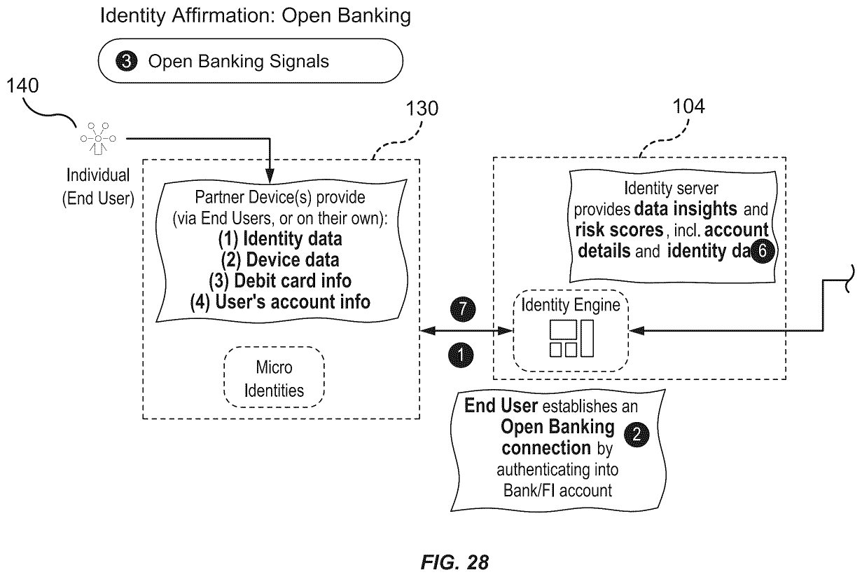

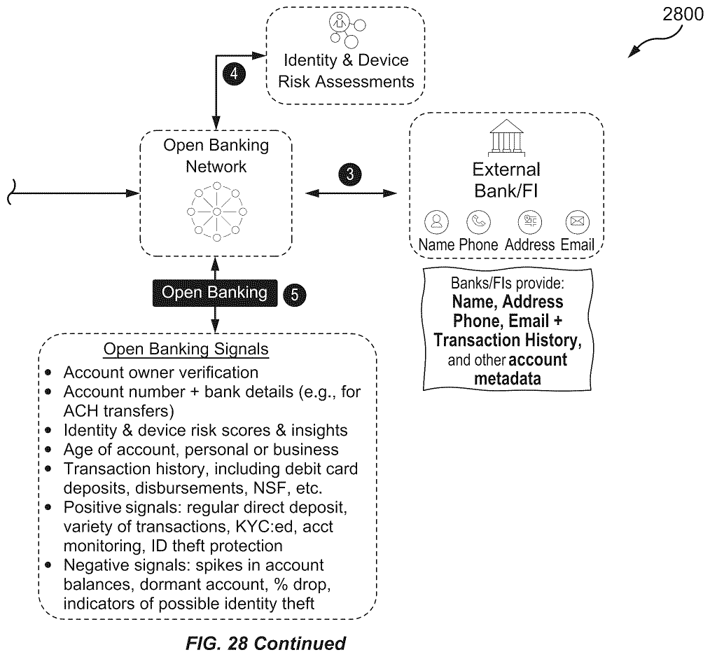

FIG. 28 is a diagram illustrating an example of identity affirmation 2800 with open banking, in accordance with various aspects of the present disclosure. As illustrated in FIG. 28, the partner device 130 requests the identity server 104 to perform a risk assessment on whether to the trust the anonymous identity of the individual 140 based on the information that was provided to the partner device 130 (operation 1). The information provided to the identity server 104 includes identity data, device data, debit card information, and user's account information that are from micro identities. The individual 140 also establishes an open banking connection by authenticating into a bank/FI account of an external bank/FI (operation 2).

The external bank/FI provides the name, address, phone, email, transaction history, other suitable account information, or a combination thereof to the identity server 104 (at operation 3). The identity server 104 performs identity and device risk assessments (at operation 4).

The identity server 104 also determines open banking signals including account owner verification, account number and bank details (e.g., for ACH transfers), identity and device risk scores and insights, age of account (e.g., personal or business accounts), transaction history (including debit card deposits, disbursements, non-sufficient funds (NSF), etc.), positive signals (e.g., regular direct deposit, variety of transactions, KYC, account monitoring, ID theft protection), and negative signals (e.g., spikes in account balances, dormant account, percentage drop, indicators of possible identity theft). In response to determining open banking signals, the identity server 104 provides data insights, risk scores, account details, and identity data to the partner device 130 (operations 6 and 7).

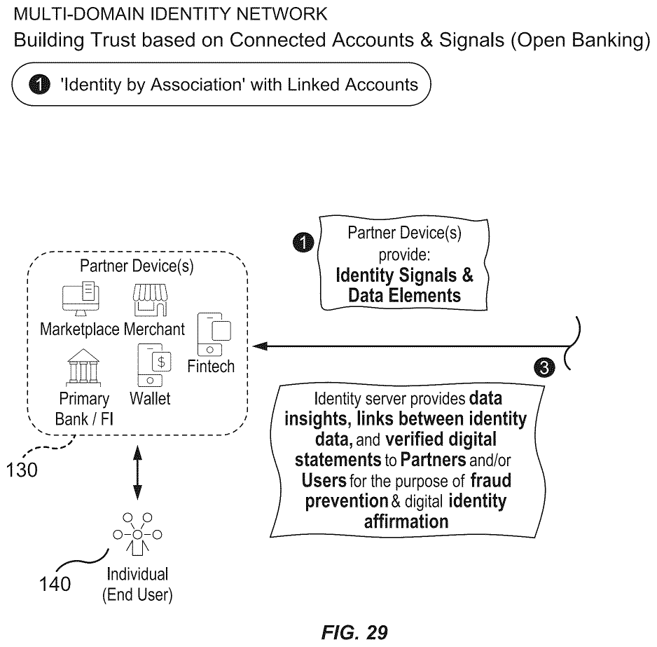

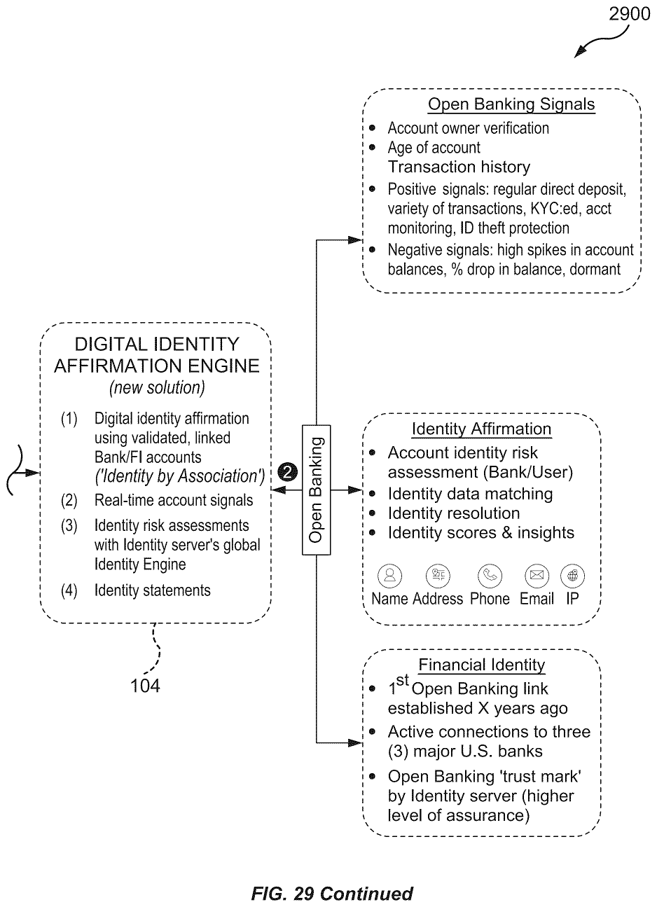

FIG. 29 is a diagram illustrating an example 2900 of building trust based on connected accounts and open banking signals, in accordance with various aspects of the present disclosure. As illustrated in FIG. 29, the partner device 130 requests the identity server 104 to perform a risk assessment on whether to the trust the anonymous identity of the individual 140 based on the information that was provided to the partner device 130 (operation 1). The information including identity signals and data elements as described herein.

The identity server 104 performs a digital identity affirmation with a digital identity affirmation engine (at operation 4). The digital identity affirmation may include some or all of the following: 1) a digital identity affirmation using validated, linked bank/FI accounts (“identity by association”), 2) real-time account signals, 3) identity risk assessments with the global identity engine of the identity server 104, and 4) identity statements.

With respect to open banking signals, the identity server 104 may determine, with accessing the open banking network, account owner verification, account number and bank details (e.g., for ACH transfers), identity and device risk scores and insights, age of account (e.g., personal or business accounts), transaction history (including debit card deposits, disbursements, NSF, etc.), positive signals (e.g., regular direct deposit, variety of transactions, KYC, account monitoring, ID theft protection), and negative signals (e.g., spikes in account balances, dormant account, percentage drop, indicators of possible identity theft).

With respect to identity affirmation, the identity server 104 may perform some or all of the following: 1) account identity risk assessment (bank/user), 2) identity data matching, 3) identity resolution, and 4) identity scores and insights.

With respect to financial identity, the identity server 104 may determine some or all of the following: 1) first open banking link and associated age, 2) active links to major bank/FI, and 3) open banking “trust mark” by the identity server 104, which indicates a higher level of assurance.

In response to performing the digital identity affirmation with the digital identity affirmation engine, the identity server 104 provides data insights, links between identity data, and verified digital statements to partners and/or users for the purpose of fraud prevention and digital identity affirmation (operation 3).

The following are enumerated examples of the devices, methods, and non-transitory computer-readable media of the present disclosure. Example 1: a server comprising: a memory, a communication interface configured to communicate with a partner device, and an electronic processor that is configured to receive first information regarding an anonymous identity of an individual, perform a digital identity affirmation regarding the anonymous identity of the individual based on the first information that is received, and transmit second information regarding the digital identity affirmation to the partner device, the second information indicating an amount of trust of the anonymous identity.

Example 2: the server of Example 1, wherein the communication interface is further configured to communicate with an open banking network, and wherein the first information is information of a linked financial account that is received via the open banking network.

Example 3: the server of Example 2, wherein the information of the linked financial account includes one or more of: an account owner verification, an account number and bank details, identity and device risk scores and insights, an age of account, a transaction history, know-your-customer (KYC) information, indication of account monitoring, indication of ID theft protection, indication of a dormant account, and an indication of a percentage drop.

Example 4: the server of Example 3, wherein the information of the linked financial account includes a first open banking link and associated age, active links to major financial institutions, and an open banking “trust mark” that indicates a higher level of assurance.

Example 5: the server of any of Examples 1-4, wherein to perform the digital identity affirmation regarding the anonymous identity of the individual based on the first information that is received, the electronic processor is further configured to perform an account identity risk assessment, perform identity data matching, perform identity resolution, and generate identity scores and insights.

Example 6: the server of Example 5, wherein to perform identity resolution, the electronic processor is further configured to identify unique information in the first information with respect to the anonymous identity, determine whether the first information of anonymous identity is deficient based on the unique information that is identified, and transmit a message to the individual with the anonymous identity indicating that the first information is deficient and indicating other anonymized information that supplements the anonymous identity and corrects the deficiency.

Example 7: the server of any of Examples 1-6, wherein the second information includes one or more of data insights of the anonymous identity, links between identity data of the anonymous identity, and verified digital statements associated with the anonymous identity.

Example 8: a method comprising: receiving, with an electronic processor, first information regarding an anonymous identity of an individual; performing, with the electronic processor, a digital identity affirmation regarding the anonymous identity of the individual based on the first information that is received; and transmitting, with the electronic processor, second information regarding the digital identity affirmation to a partner device, the second information indicating an amount of trust of the anonymous identity.

Example 9: the method of Example 8, wherein the first information is information of a linked financial account that is received via an open banking network.

Example 10: the method of Example 9, wherein the information of the linked financial account includes one or more of: an account owner verification, an account number and bank details, identity and device risk scores and insights, an age of account, a transaction history, know-your-customer (KYC) information, indication of account monitoring, indication of ID theft protection, indication of a dormant account, and an indication of a percentage drop.

Example 11: the method of Example 10, wherein the information of the linked financial account includes a first open banking link and associated age, active links to major financial institutions, and an open banking “trust mark” that indicates a higher level of assurance.

Example 12: the method of any of Examples 8-11, wherein performing the digital identity affirmation regarding the anonymous identity of the individual based on the first information that is received further includes performing an account identity risk assessment, performing identity data matching, performing identity resolution, and generating identity scores and insights.

Example 13: the method of Example 12, wherein performing the identity resolution further includes identifying unique information in the first information with respect to the anonymous identity, determining whether the first information of anonymous identity is deficient based on the unique information that is identified, and transmitting a message to the individual with the anonymous identity indicating that the first information is deficient and indicating other anonymized information that supplements the anonymous identity and corrects the deficiency.

Example 14: the method of any of Examples 8-13, wherein the second information includes one or more of data insights of the anonymous identity, links between identity data of the anonymous identity, and verified digital statements associated with the anonymous identity.

Example 15: a non-transitory computer-readable medium comprising instructions that, when executed by an electronic processor, cause the electronic processor to perform a set of operations comprising: controlling a communication interface to receive first information regarding an anonymous identity of an individual; performing a digital identity affirmation regarding the anonymous identity of the individual based on the first information that is received; and controlling the communication interface to transmit second information regarding the digital identity affirmation to a partner device, the second information indicating an amount of trust of the anonymous identity.

Example 16: the non-transitory computer-readable medium of Example 15, wherein the first information is information of a linked financial account that is received via an open banking network.

Example 17: the non-transitory computer-readable medium of Example 16, wherein the information of the linked financial account includes one or more of: an account owner verification, an account number and bank details, identity and device risk scores and insights, an age of account, a transaction history, know-your-customer (KYC) information, indication of account monitoring, indication of ID theft protection, indication of a dormant account, and an indication of a percentage drop.

Example 18: the non-transitory computer-readable medium of any of Examples 15-17, wherein performing the digital identity affirmation regarding the anonymous identity of the individual based on the first information that is received further includes performing an account identity risk assessment, performing identity data matching, performing identity resolution, and generating identity scores and insights.

Example 19: the non-transitory computer-readable medium of Example 18, wherein performing the identity resolution further includes identifying unique information in the first information with respect to the anonymous identity, determining whether the first information of anonymous identity is deficient based on the unique information that is identified, and controlling the communication interface to transmit a message to the individual with the anonymous identity indicating that the first information is deficient and indicating other anonymized information that supplements the anonymous identity and corrects the deficiency.

Example 20: the non-transitory computer-readable medium of any of Examples 15-19, wherein the second information includes one or more of data insights of the anonymous identity, links between identity data of the anonymous identity, and verified digital statements associated with the anonymous identity.

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments, examples, aspects, and features may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, one or more of the embodiments, examples, aspects, and features presented herein can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It should thus be noted that the matter contained in the above description or shown in the accompanying drawings is to be interpreted as illustrative and not in a limiting sense.

What is claimed is:

1. A server comprising:
a memory,
a communication interface configured to communicate with a partner device, and
an electronic processor that is configured to
receive first information regarding an anonymous identity of an individual,
perform a digital identity affirmation regarding the anonymous identity of the individual based on the first information that is received, and
transmit second information regarding the digital identity affirmation to the partner device, the second information indicating an amount of trust of the anonymous identity.

2. The server of claim 1, wherein the communication interface is further configured to communicate with an open banking network, and wherein the first information is information of a linked financial account that is received via the open banking network.

3. The server of claim 2, wherein the information of the linked financial account includes one or more of:
an account owner verification,
an account number and bank details,
identity and device risk scores and insights,
an age of account,
a transaction history,
know-your-customer (KYC) information,
indication of account monitoring,
indication of ID theft protection,
indication of a dormant account, and
an indication of a percentage drop.

4. The server of claim 3, wherein the information of the linked financial account includes a first open banking link and associated age, active links to major financial institutions, and an open banking “trust mark” that indicates a higher level of assurance.

5. The server of claim 1, wherein to perform the digital identity affirmation regarding the anonymous identity of the individual based on the first information that is received, the electronic processor is further configured to
perform an account identity risk assessment,
perform identity data matching,
perform identity resolution, and
generate identity scores and insights.

6. The server of claim 5, wherein to perform identity resolution, the electronic processor is further configured to
identify unique information in the first information with respect to the anonymous identity,
determine whether the first information of anonymous identity is deficient based on the unique information that is identified, and
transmit a message to the individual with the anonymous identity indicating that the first information is deficient and indicating other anonymized information that supplements the anonymous identity and corrects the deficiency.

7. The server of claim 1, wherein the second information includes one or more of data insights of the anonymous identity, links between identity data of the anonymous identity, and verified digital statements associated with the anonymous identity.

8. A method comprising:
receiving, with an electronic processor, first information regarding an anonymous identity of an individual;
performing, with the electronic processor, a digital identity affirmation regarding the anonymous identity of the individual based on the first information that is received; and
transmitting, with the electronic processor, second information regarding the digital identity affirmation to a partner device, the second information indicating an amount of trust of the anonymous identity.

9. The method of claim 8, wherein the first information is information of a linked financial account that is received via an open banking network.

10. The method of claim 9, wherein the information of the linked financial account includes one or more of:
an account owner verification,
an account number and bank details,
identity and device risk scores and insights,
an age of account,
a transaction history,
know-your-customer (KYC) information,
indication of account monitoring,
indication of ID theft protection,
indication of a dormant account, and
an indication of a percentage drop.

11. The method of claim 10, wherein the information of the linked financial account includes a first open banking link and associated age, active links to major financial institutions, and an open banking “trust mark” that indicates a higher level of assurance.

12. The method of claim 8, wherein performing the digital identity affirmation regarding the anonymous identity of the individual based on the first information that is received further includes
performing an account identity risk assessment,
performing identity data matching,
performing identity resolution, and
generating identity scores and insights.

13. The method of claim 12, wherein performing the identity resolution further includes
identifying unique information in the first information with respect to the anonymous identity,
determining whether the first information of anonymous identity is deficient based on the unique information that is identified, and
transmitting a message to the individual with the anonymous identity indicating that the first information is deficient and indicating other anonymized information that supplements the anonymous identity and corrects the deficiency.

14. The method of claim 8, wherein the second information includes one or more of data insights of the anonymous identity, links between identity data of the anonymous identity, and verified digital statements associated with the anonymous identity.

15. A non-transitory computer-readable medium comprising instructions that, when executed by an electronic processor, cause the electronic processor to perform a set of operations comprising:
controlling a communication interface to receive first information regarding an anonymous identity of an individual;
performing a digital identity affirmation regarding the anonymous identity of the individual based on the first information that is received; and
controlling the communication interface to transmit second information regarding the digital identity affirmation to a partner device, the second information indicating an amount of trust of the anonymous identity.

16. The non-transitory computer-readable medium of claim 15, wherein the first information is information of a linked financial account that is received via an open banking network.

17. The non-transitory computer-readable medium of claim 16, wherein the information of the linked financial account includes one or more of:
an account owner verification,
an account number and bank details,
identity and device risk scores and insights,
an age of account,
a transaction history,
know-your-customer (KYC) information,
indication of account monitoring,
indication of ID theft protection,
indication of a dormant account, and
an indication of a percentage drop.

18. The non-transitory computer-readable medium of claim 15, wherein performing the digital identity affirmation regarding the anonymous identity of the individual based on the first information that is received further includes
performing an account identity risk assessment,
performing identity data matching,
performing identity resolution, and
generating identity scores and insights.

19. The non-transitory computer-readable medium of claim 18, wherein performing the identity resolution further includes
identifying unique information in the first information with respect to the anonymous identity,
determining whether the first information of anonymous identity is deficient based on the unique information that is identified, and
controlling the communication interface to transmit a message to the individual with the anonymous identity indicating that the first information is deficient and indicating other anonymized information that supplements the anonymous identity and corrects the deficiency.

20. The non-transitory computer-readable medium of claim 15, wherein the second information includes one or more of data insights of the anonymous identity, links between identity data of the anonymous identity, and verified digital statements associated with the anonymous identity.
